(19) United States
(12) Patent Application Publication
(10) Pub. No.: US 2014/0021776 A1
(43) Pub. Date: Jan. 23, 2014

(54) Brake Fluid Pressure Control System of Motor Vehicle

(71) Applicant: Hitachi Automotive systems, Ltd., Hitachinaka-shi (JP)

(72) Inventor: Hiroshi FURUYAMA, Atsugi-shi (JP)

(21) Appl. No.: 13/913,612

(22) Filed: Jun. 10, 2013

(30) Foreign Application Priority Data
Jul. 17, 2012 (JP) 2012-158840

(51) Int. Cl. B60T 8/17; B60T 13/14; B60T 13/66

(52) U.S. Cl. CPC B60T 8/17; B60T 13/66; B60T 13/142
USPC 303/9.62; 303/10; 303/113.1

(57) ABSTRACT

In order to provide a hydraulic brake system of a motor vehicle that damps noises that would be produced under a vehicle running support brake control and damps uncomfortable feeling that would be applied to a driver when a brake pedal stroke takes place, there is proposed a brake fluid pressure control system in which a fluid pressure required by a selected brake cylinder of a road wheel is calculated based on a behavior of the motor vehicle, and for obtaining the required fluid pressure required by the selected brake cylinder, an upstream side brake fluid pressure controlling device is operated to increase the brake cylinder fluid pressure to a given pressure and thereafter a downstream side brake fluid pressure controlling device is operated to further increase the brake cylinder fluid pressure.

### BACKGROUND OF THE INVENTION

1. Field of the Invention

The present invention relates in general to hydraulic brake systems of a motor vehicle and more particularly to brake fluid pressure control systems of a type that is able to damp noises that would be produced under operation of a vehicle running to support brake control and damps uncomfortable feeling that would be applied to a driver when a so-called brake pedal stroke is produced.

2. Description of Related Art

In order to clarify the present invention, one conventional is brake pressure control system disclosed in Japanese Laid-open Patent Application (tokkai) 2007-38764 will be briefly described in the following.

The conventional brake fluid pressure control system of the publication generally comprises a master cylinder, a fluid pressure controller (or fluid pressure controlling booster) that selectively increases and decreases the pressure of the master cylinder (viz., master cylinder pressure) in accordance with a control command from the outside and an ABS (anti-lock brake system) fluid pressure control circuit that is arranged between the master cylinder and a cluster of brake cylinders of road wheels and includes electric control valves for the brake cylinders of the road wheels, pumps that apply pressure to the fluid in the master cylinder when driven, a pump motor that drives the pumps and a brake controller. Due to operation of the brake controller, only in a decompression mode during the ABS control, the pump motor is drivingly controlled, and during a running support brake control, brake cylinders for road wheels that need braking force are subjected to increasing/decreasing of fluid pressure with the aid of the fluid pressure controller and the electric control valves while keeping the pump motor stopped.

With this conventional brake fluid pressure control system, noises that would be produced under operation of the running support brake control is sufficiently suppressed.

### SUMMARY OF THE INVENTION

However, it has been revealed that the above-mentioned conventional system has the following drawback due to its inherent construction. That is, since, in the conventional system, to the fluid pressure for the brake cylinders of road wheels is produced with the aid of the fluid pressure controller and the control of the ABS fluid pressure control circuit is effected by using the electric control valves, there is a high possibility that a sufficient fluid pressure can not be quickly obtained even in case of urgent need of high pressure application.

The present invention is provided by taking the above-mentioned drawback into consideration and aims to provide a brake fluid pressure control system that has a sufficient fluid pressure application characteristic while suppressing or at least minimizing noises that would be produced under operation of the running support brake control.

In the present invention, a required fluid pressure for each brake cylinder is calculated in accordance with a vehicle behavior, an upstream side brake fluid pressure controlling device is operated for obtaining the required fluid pressure, and then the required fluid pressure thus obtained is increased by a downstream side brake fluid pressure controlling device.

In accordance with a first aspect of the present invention, there is provided a brake fluid pressure control system of a motor vehicle, which comprises a master cylinder (21) that produces a fluid pressure in response to a brake pedal manipulation by a driver; electric pumps (31P, 31S) that increase the fluid pressure in the master cylinder (21) when operated; an upstream side brake fluid pressure controlling device (22) that boosts the fluid pressure in the master cylinder (21); electric control valves arranged between the master cylinder (21) and a cluster of the brake cylinders (42FL, 42RR, 42FR, 42RL) of road wheels of the vehicle; a downstream side brake fluid pressure controlling device (3) that controls the fluid pressure of the brake cylinders with the aid of operation of the electric pumps and the electric control valves; and a control unit (6) that controls the upstream and downstream side brake fluid pressure controlling devices, wherein the control unit comprises a required brake cylinder fluid pressure calculating section (63) that calculates a required brake cylinder fluid pressure in accordance with a behavior of the vehicle; a first brake cylinder fluid pressure controlling section that controls the upstream side brake fluid pressure controlling device (22) for is obtaining the required brake cylinder fluid pressure thus calculated; and a second brake cylinder fluid pressure controlling section that controls the downstream side brake fluid pressure controlling device (3) for increasing the brake cylinder fluid pressure thus obtained by the first brake cylinder fluid pressure controlling section.

In accordance with a second aspect of the present invention, there is provided a brake fluid pressure control system of a motor vehicle, which comprises a master cylinder (21) that produces a fluid pressure in response to a brake pedal manipulation by a driver; electric pumps (31P, 31S) that increase the fluid pressure in the master cylinder (21) when operated; an upstream side brake fluid pressure controlling device (22) that boosts the fluid pressure in the master cylinder (21); electric control valves arranged between the master cylinder (21) and a cluster of the brake cylinders (42FL, 42RR, 42FR, 42RL) of the road wheels; a downstream side brake fluid pressure controlling device (3) that controls the fluid pressure of the brake cylinders with the aid of operation of the electric pumps and the electric control valves; a required brake cylinder fluid pressure calculating section that calculates a required brake cylinder fluid pressure required by each brake cylinder based on a vehicle behavior; a first brake cylinder fluid pressure controlling section that causes the upstream, side brake fluid pressure controlling device (22) to operate until the time when the brake cylinder fluid pressure is increased to a predetermined fluid pressure; and a second brake cylinder fluid pressure controlling section that causes the downstream side brake fluid pressure controlling device to boost the increased brake fluid pressure after the time when the brake cylinder fluid pressure exceeds the predetermined fluid pressure.

In accordance with a third aspect of the present invention, there is provided, in a hydraulic brake system of a motor vehicle that includes a master cylinder (21) that produces a fluid pressure in response to a brake pedal manipulation by a driver, electric pumps (31P, 31S) that increase the fluid pressure in the master cylinder (21) when operated; an upstream side brake fluid pressure controlling device (22) that boosts the fluid pressure in the master cylinder (21), electric control valves arranged between the master cylinder (21) and a cluster of the brake cylinders of the road wheels and a downstream side brake fluid pressure controlling device (3) that controls the fluid pressure of the brake cylinders with the aid of operation of the electric pumps and the electric control valves, there is provided a method of controlling the hydraulic brake system, which comprises calculating a fluid pressure required by a brake cylinder of a selected road wheel based on a behavior of the motor vehicle; operating the upstream side brake fluid pressure controlling device until the time when the required brake cylinder fluid pressure increases to a predetermined fluid pressure; and operating the downstream side brake fluid pressure controlling device while keeping the operation of the upstream side brake fluid pressure controlling device after the time when the required brake cylinder fluid pressure exceeds the predetermined fluid pressure.

### BRIEF DESCRIPTION OF THE DRAWINGS

Other objects and advantages of the present invention will become apparent from the following description when taken in conjunction of the accompanying drawings, in which:

FIG. 1 is a schematic diagram of a brake fluid pressure control system of a first embodiment of the present invention;

FIG. 2 is a block diagram of the brake fluid pressure control system of the first embodiment;

FIG. 3 is a detailed view of a fluid pressure circuit possessed by a fluid pressure control unit employed in the first embodiment;

FIG. 4 is a flowchart showing a flow of programmed operation steps executed for controlling the brake fluid pressure is in the first embodiment;

FIG. 5 is a graph showing a relation between an instructed fluid pressure for an electric booster and a brake pedal stroke in a conventional example;

FIG. 6 is a graph showing a relation between a brake fluid pressure in one of primary and secondary fluid systems and a brake fluid amount in the first embodiment;

FIG. 7 is a time chart showing changes of a brake cylinder fluid pressure for a front road wheel, a brake cylinder fluid pressure for a rear road wheel and a master cylinder fluid pressure with respect to an elapsed time in the first embodiment;

FIG. 8 is a time chart depicting operation manner of the brake fluid pressure control system of the first embodiment at the time when, with a required brake cylinder fluid pressure being high, the system is conducting a vehicle behavior stabilizing control;

FIG. 9 is a time chart similar to that of FIG. 8, but depicting the operation manner of the system at the time when, with the required brake cylinder fluid pressure being low, the system is conducting the vehicle behavior stabilizing control;

FIG. 10 is a flowchart similar to FIG. 4, but showing a flow of programmed operations steps executed in a second embodiment of the present invention;

FIG. 11 is a time chart depicting operation manner of the brake fluid pressure control system of the second embodiment at the time when, during an oversteer suppressing control, an accelerator pedal is manipulated by a driver for effecting TCS control;

FIG. 12 is a flowchart similar to FIG. 4, but showing a flow of programmed operation steps executed in a third embodiment of the present invention;

FIG. 13 is a time chart depicting operation manner of the is brake fluid pressure control system of the third embodiment at the time when the vehicle behavior stabilizing control is being carried out;

FIG. 14 is a flowchart similar to FIG. 4, but showing a flow of programmed operation steps executed in a fourth embodiment of the present invention;

FIG. 15 is a graph showing a relation between a brake cylinder fluid pressure and a master cylinder fluid pressure at the time when ABS control is being carried out in the fourth embodiment;

FIG. 16 is a time chart depicting operation manner of the brake fluid pressure control system of the fourth embodiment at the time when the vehicle behavior stabilizing control is being carried out;

FIG. 17 is a flow chart similar to FIG. 4, but showing a flow of programmed operation steps executed in a fifth embodiment of the present invention;

FIG. 18 is a time chart depicting operation manner of the brake fluid pressure control system of the fifth embodiment at the time when the vehicle behavior stabilizing control is being carried out;

FIG. 19 is a flow chart similar to FIG. 4, but showing a flow of programmed operation steps executed in a fifth embodiment of the present invention;

FIG. 20 is a time chart depicting operation manner of the brake fluid pressure control system of the sixth embodiment at the time when the vehicle behavior stabilizing control is being carried out;

FIG. 21 is a flow chart similar to FIG. 4, but showing a flow of programmed operation steps executed in a seventh embodiment of the present invention;

FIG. 22 is a time chart depicting operation manner of the brake fluid pressure control system of the seventh embodiment at the time when the vehicle behavior stabilizing control is being carried out;

FIG. 23 is a flow chart similar to FIG. 4, but showing a flow of programmed operation steps executed in an eighth embodiment of the present invention;

FIG. 24 is a time chart depicting operation manner of the brake fluid pressure control system of the eighth embodiment at the time when the vehicle behavior stabilizing control is being carried out;

FIG. 25 is a flow chart similar to FIG. 4, but showing a flow of programmed operation steps executed in a ninth embodiment of the present invention;

FIG. 26 is a time chart depicting operation manner of the brake fluid pressure control system of the ninth embodiment at the time when the vehicle behavior stabilizing control is being carried out;

FIG. 27 is a flow chart similar to FIG. 4, but showing a flow of programmed operation steps executed in a tenth embodiment of the present invention; and

FIG. 28 is a time chart depicting operation manner of the brake fluid pressure control system of the tenth embodiment at the time when the vehicle behavior stabilizing control is being carried out.

### DETAILED DESCRIPTION OF THE INVENTION

In the following, the brake fluid pressure control system of the present invention will be described in detail with reference to the accompanying drawings. For ease of understanding, the description of the control system will be directed to ten embodiments E-1 to E-10 of the present invention.

### First Embodiment (E-1)

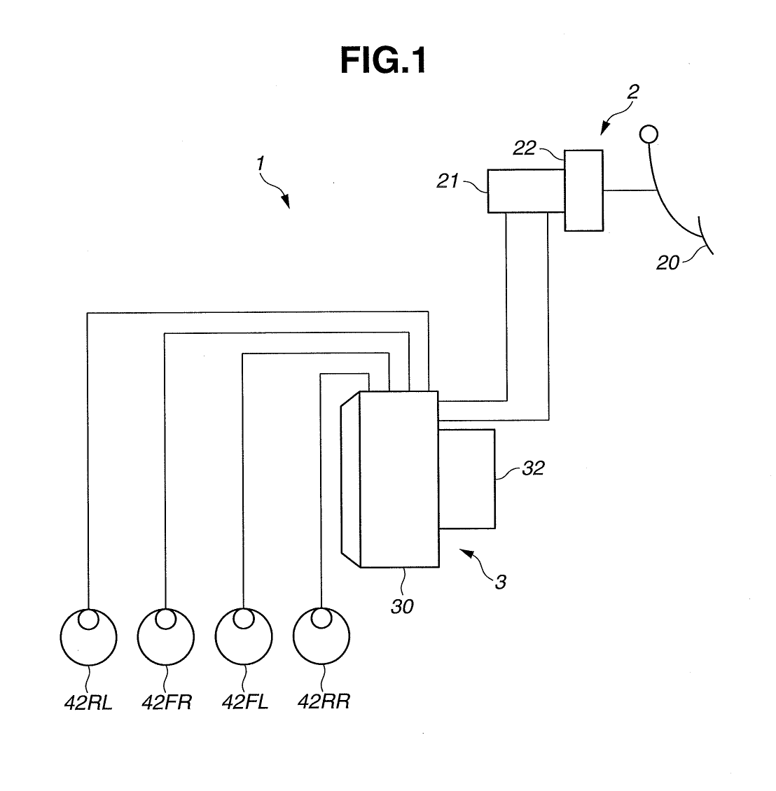

In the following, a first embodiment E-1 of the brake fluid pressure control system 1 of the present invention will be described with reference to FIGS. 1 to 9.

Referring to FIG. 1, there is shown a general view of the system 1 of the first embodiment.

As is seen from this drawing, the system 1 has, in addition to a service brake 2, a fluid pressure control unit 3 that is capable of producing a brake fluid pressure.

The service brake 2 increases a brake fluid pressure in a master cylinder 21 upon depression of a brake pedal 20 by a driver and has an electric booster 22 that boosts the increased brake fluid pressure in the master cylinder 21. In the following, the brake fluid pressure in the master cylinder 21 will be referred to “master cylinder fluid pressure”.

The electric booster 22 has such a function as to automatically boost the master cylinder fluid pressure even when the brake pedal 20 is not depressed.

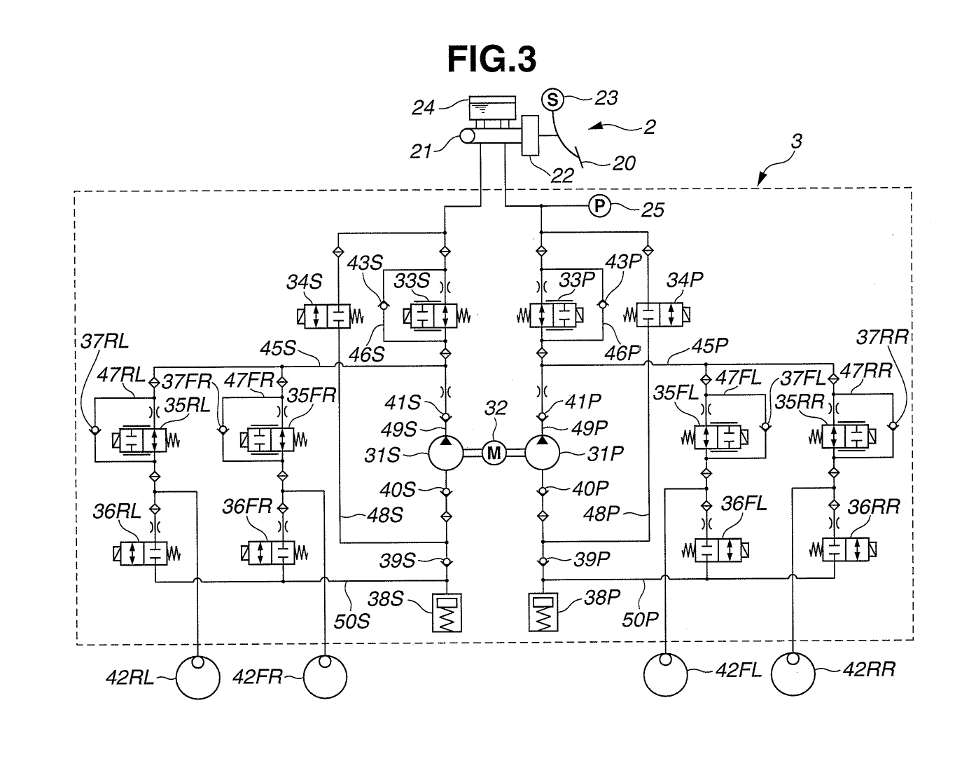

Designated by numeral 3 is a fluid pressure control unit 3 that has fluid passages in a housing 30. Various control valves (not shown in FIG. 1) are operatively installed in the fluid passages of the housing 30. Within the housing 30, there are installed pumps 31P and 31S (see FIG. 3) that are driven by a common electric motor 32. Due to work of the pumps 31P and 31S, the fluid pressure in the master cylinder 21 of the service brake 2 can be boosted or increased before being applied to brake cylinders 42RL, 42FR, 42FL and 42RR of four road wheels. Even when the master cylinder fluid pressure is not produced by the service brake 2, the work of pumps 31P and 31S can provide the four brake cylinders 42RL, 42FR, 42FL and 42RR with suitable brake fluid pressure. Under ABS (anti-lock braking system) control, the brake fluid reserved in reservoirs 38P and 38S (see FIG. 3) can be returned to master cylinder 21 by the function of the pumps 31P and 31S.

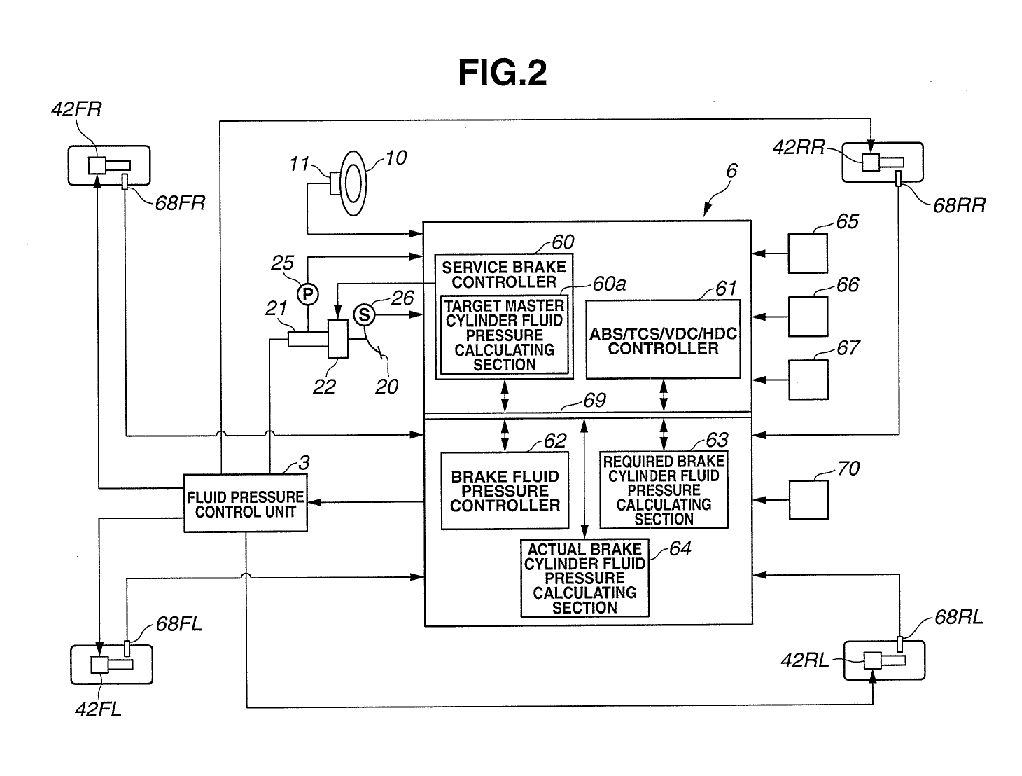

Referring to FIG. 2, there is shown a block diagram of the brake fluid pressure control system 1 of the first embodiment.

As shown, the system 1 is equipped with a brake controller is 6 that is capable of entirely controlling the brake system.

As shown, to the brake controller 6, there are inputted various information signals, which are wheel speed representing signals from wheel speed sensors 68FL, 68FR, 68RL and 68RR mounted on the four road wheels, a yaw rate representing signal from a yaw rate sensor 65, a lateral acceleration representing signal from a lateral acceleration sensor 66, a longitudinal acceleration representing signal from a longitudinal acceleration sensor 67, a steering angle representing signal from a steering angle sensor 11 fitted to a steering wheel 10, a master cylinder fluid pressure representing signal from a master cylinder fluid pressure sensor 25, a brake pedal stroke amount representing signal from a stroke sensor 26 for the brake pedal 20 and a failure information representing signal on the service brake 2 from a service brake failure detecting section 70. The failure information representing signal on the service brake 2 indicates whether the electric booster 22 is normal or abnormal (viz., in failure).

The brake controller 6 comprises a service brake controller 60 that controls the electric booster 22, an ABS/TCS/ESC/HDC (Anti-lock Brake System/Traction Control System/Electronic Stability Control/Hill Descent Control) controller 61 that carries out a running support brake control and a brake support brake control, a brake fluid pressure controller 62 that controls the pumps 31P and 31S and the various control valves in the fluid pressure control unit 3, a required brake cylinder fluid pressure calculating section 63 that calculates a brake cylinder fluid pressure required for each brake cylinder 42RL, 42FR, 42FL or 42RR and an actual brake cylinder fluid pressure calculating section 64 that calculates a brake cylinder fluid pressure actually appearing in each brake cylinder 42RL, 42FR, 42FL or 42RR.

As shown, the service brake controller 60 is equipped with a target master cylinder fluid pressure calculating section 60a. The controllers 60, 61 and 62 and the calculating sections 60a, 63 and 64 are connected to CAN (Controller Area Network) 69 to carry out information exchange among them.

It is to be noted that ABS represents Anti-lock brake system that suppresses a locked condition of each road wheel upon braking, TCS represents Traction control system that suppresses a road wheel spin upon vehicle starting and/or acceleration, ECS represents Electronic stability control that suppresses a sideslip of the vehicle and HDC represents Hill descent control that controls the vehicle at a speed that appeared when, with the vehicle running on a downhill, the brake pedal was released. In the specification, ABS is called as brake support brake control, and TCS, ECS and HDC are called as running support brake control.

Referring to FIG. 3, there is shown the detail of a fluid pressure circuit possessed by the fluid pressure control unit 3.

As shown, the fluid pressure circuit consists of the primary and secondary fluid line systems. To the primary fluid line system, there are connected the left-front road wheel brake cylinder 42FL and the right-rear road wheel brake cylinder 42RR, and to the secondary fluid line system, there are connected the right-front road wheel brake cylinder 42FR and the left-rear road wheel brake cylinder 42RL, so that a so-called “X-piping” is arranged between the four road wheel brake cylinders 42RL, 42FR, 42FL and 42RR.

For ease of understanding, some parts used for the primary fluid line system will be indicated by the addition of the letter “P” after each reference numeral while those used for the secondary fluid line system will be indicated by the addition of the letter “S” after each corresponding reference numeral. However, when it is meaningless to distinguish the two fluid line systems, such letters “P” and “S” will be deleted from the description. Furthermore, although the brake cylinders are indicated by 42RL, 42FR, 42FL and 42RR, the references “RL”, “FR”, “FL” and “RR” will be deleted when it is meaningless to distinguish the positions of the brake cylinders.

As shown in FIG. 3, the primary and secondary fluid line systems have the pumps 31P and 31S respectively. These two pumps 31P and 31S are driven by the common electric motor 32.

The left-front brake cylinder 42FL and the right-rear brake cylinder 42RR are connected to the master cylinder 21 through a fluid passage 45P, while the right-front brake cylinder 42FR and the left-rear brake cylinder 42RL are connected to the master cylinder 21 through a fluid passage 45S.

Each fluid passage 45P or 45S is equipped with a gate-out valve 33P or 33S that is of a normally open proportional type. Each fluid passage 45P or 45S has a bypass passage 46P or 46S that bypasses the gate-out valve 33P or 33S. The bypass passage 46P or 46S is equipped with a one-way valve 43P or 43S that permits only one way fluid flow from the master cylinder 21 toward the road wheel brake cylinders 42.

Each fluid passage 45P or 45S is provided, at a position between the gate-out valve 33P or 33S and the brake cylinders 42FL and 42RR (or 42FR and 42RL), with pressure increasing valves 35FL and 35RR (or 35FR and 35RL) respectively. These pressure increasing valves are of a normally open proportional type. Furthermore, each fluid passage 45P or 45S is equipped with bypass passages 47FL and 47RR (or 47FR and 47RL) that bypass the 35FL and 35RR (or 35FR and 35RL) respectively. Each bypass passage 47FL, 47RR, 47FR or 47RL is equipped with a one-way valve 37FL, 37RR, 37FR or 37RL that permits only one-way fluid flow from the brake cylinder 42FL, 42RR, 42FR or 42RL toward the master cylinder 21.

The master cylinder 21 and an inlet side of the pump 31P or 31S are connected through a fluid passage 48P or 48S. Each fluid passage 48P or 48S is equipped with a gate-in valve 34P or 34S that is of a normally closed ON/OFF type. Each fluid passage 48P or 48S is provided, at a position between the pump 31P or 31S and the gate-in valve 34P or 34S, with an inlet valve 40P or 40S that permits only one-way fluid flow directed toward the pump 31P or 31S.

A conjunction portion between the pressure increasing valve 35FL, 35RR, 35FR or 35RL of the fluid passage 45P or 45S and the corresponding brake cylinder 42FL, 42RR, 42FR or 42RL and a conjunction portion between the gate-in valve 34P or 34S of the fluid passage 48P or 48S and the inlet valve 40P or 40S are connected through a fluid passage 50P or 50S, and each fluid passage 50P or 50S is equipped with a pressure reducing valve 36FL, 36RR, 36FR or 36RL. A reservoir 38P or 38S is connected to a conjunction portion of the fluid passage 50P or 50S between the pressure reducing valve 36FL, 36RR, 36FR or 36RL and the inlet valve 40P or 40S. A one-way valve 39P or 39S is connected to the fluid passage 50P or 50S at a position between the reservoir 38P or 38S and the inlet valve 40P or 40S. The one-way valve 39P or 39S permits only a fluid flow from the reservoir 38P or 38S toward the pump 31P or 31S.

The fluid passage 45P of the primary line system is provided, at a position between the master cylinder 21 and the gate-out valve 33P, with a fluid pressure sensor 25. However, if desired, the fluid pressure sensor 25 may be installed in the master cylinder 21.

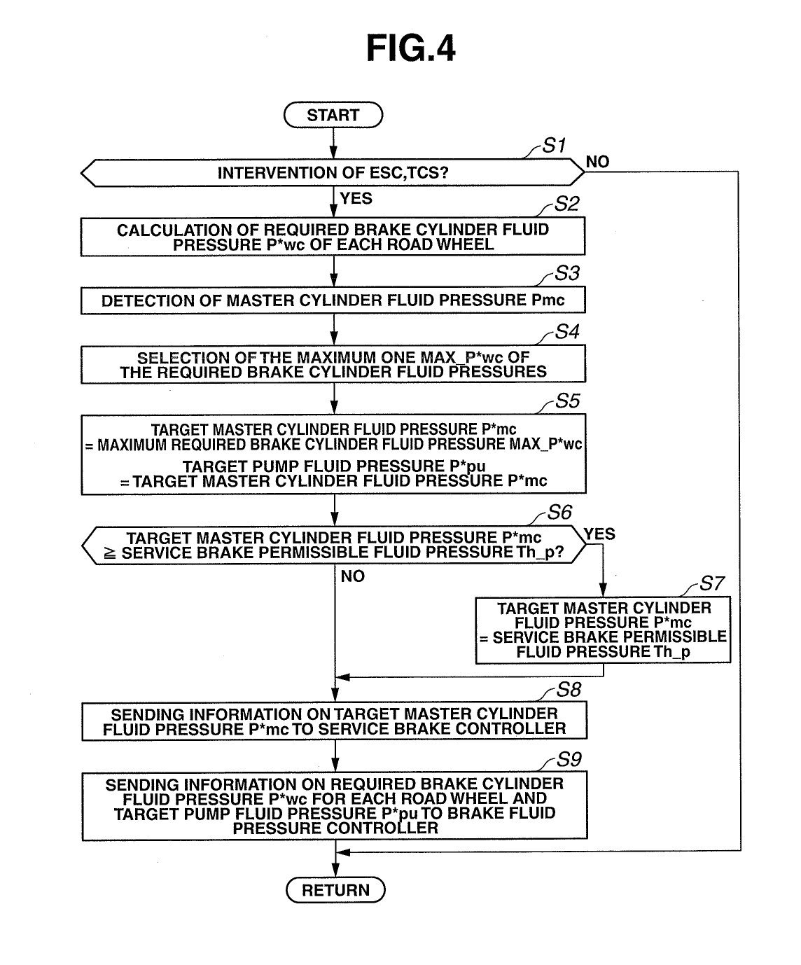

Referring to FIG. 4, there is shown a flowchart depicting programmed operation steps executed for controlling the brake fluid pressure in the first embodiment. In the following, control of the brake fluid pressure produced by the service brake 2 and control of the brake fluid pressure produced by the fluid pressure control unit 3 will be described.

At step S1, judgment is carried out as to whether the vehicle behavior stabilizing control by ESC (Electric stability control) and/or the spin suppression control by TCS (Traction control system) has taken place or not. If YES, that is, when it is judged that such control has taken place, the operation flow goes to step S2, and if NO, the operation flow goes to END. In the following description, the controls by ESC and TCS may be referred to as “vehicle behavior stabilizing control”.

At step S2, a required brake cylinder fluid pressure P*wc for each road wheel is calculated, and then the operation flow goes to step S3.

At step S3, a master cylinder fluid pressure Pmc is detected by the master cylinder fluid pressure sensor 25, and then the operation flow goes to step S4.

At step S4, the maximum one of the four required brake cylinder fluid pressures P*wc calculated at step S2 is selected as a maximum required brake cylinder fluid pressure MAX P*wc, and the operation flow goes to step S5.

At step S5, a target master cylinder fluid pressure P*mc to be produced by the service brake 2 (viz., electric booster 22) is set as the maximum required brake cylinder fluid pressure MAX P*wc, and at the same time a target pump fluid pressure P*pu to be produced by the fluid pressure control unit 3 (viz., pump 31P or 31S) is set as the target master cylinder fluid pressure P*mc, and then the operation flow goes to step S6. The target pump fluid pressure P*pu may be smaller than the target master cylinder fluid pressure P*mc. With this, if the target master cylinder fluid pressure P*mc is obtained by the electric booster 22, there is no need of driving the pumps 31P and 31S.

At step S6, judgment is carried out as to whether or not the target master cylinder fluid pressure P*mc is equal to or larger than a service brake permissible fluid pressure Th_P. If YES, that is, when the target master cylinder fluid pressure P*mc is equal to or larger than the service brake permissible fluid pressure Th_P, is the operation flow goes to step S7, if NO, that is, when the target master cylinder fluid pressure P*mc is smaller than the service brake permissible fluid pressure Th_P, the operation flow goes to step S8. Since the target master cylinder fluid pressure P*mc is equal to the maximum required brake cylinder fluid pressure MAX P*wc, the step S6 substantially carries out judgment as to whether or not the maximum required brake cylinder fluid pressure MAX P*wc is equal to or larger than the service brake permissible fluid pressure Th_P.

At step S7, the target master cylinder fluid pressure P*mc is set as the service brake permissible fluid pressure Th_P, and the operation flow goes to step S8.

At step S8, information signal on the target master cylinder fluid pressure P*mc is transmitted to the service brake controller 60, and then the operation flow goes to step S9. By the service brake controller 60, the electric booster 22 is controlled for controlling the master cylinder fluid pressure Pmc to show the target master cylinder fluid pressure P*mc.

At step S9, information signal on the required brake cylinder fluid pressure P*wc for each road wheel and information signal on the target pump fluid pressure P*pu are transmitted to the brake fluid pressure controller 62, and the operation flow terminates.

By the brake fluid pressure controller 62, the electric motor 32 is controlled to cause a pump discharge pressure Ppu of the pump 31P or 31S to take a target pump discharge pressure P*pu, and at the same time, the various valves are controlled to cause to the brake cylinder fluid pressure Pwc for each road wheel to take the required brake cylinder fluid pressure P*wc. In this case, the target pump discharge pressure P*pu is set equal to or smaller than the target master cylinder fluid pressure P*mc, and thus, when the master cylinder fluid pressure Pmc has already become the target master cylinder fluid pressure P*mc due to the work of the electric booster 22, the pumps 31P and 31S are not driven. Furthermore, the pressure increasing valve 35FL, 35RR, 35FR or 35RL for the brake cylinder 42FL, 42RR, 42FR or 42RL that has established the required brake cylinder fluid pressure P*wc is closed for keeping the fluid pressure.

In the above-mentioned arrangement, the service brake permissible fluid pressure Th_P is set. However, if desired, in place of the service brake permissible fluid pressure Th_P, an amount of fluid (viz., service brake permissible fluid amount) fed to the brake cylinder 42FL, 42RR, 42FR or 42RL may be used.

In the following, operation of the brake fluid pressure control system of the first embodiment of the present invention will be described.

As is known, in order to instantly increase the brake cylinder fluid pressure under the vehicle behavior stabilizing control, it is usually necessary to provide high power type pumps 31P and 31S and thus a high power electric motor 32 for driving the pumps 31P and 31S. However, this measure inevitably brings about a high noise of the pumps and the motor as well as increase in cost of manufacturing. Since usually the vehicle behavior stabilizing control is carried out when the vehicle is not subjected to braking, operation noise is easily heard by passengers.

In view of the above, one measure may be thought out in which in place of a negative pressure booster, the electric booster 22 is used for increasing the brake cylinder fluid pressure under the vehicle behavior stabilizing control.

However, if such measure is practically employed, the following apprehension appears. That is, due to operation of the electric booster 22, there is some possibility of movement (or stroke) of a brake pedal 20.

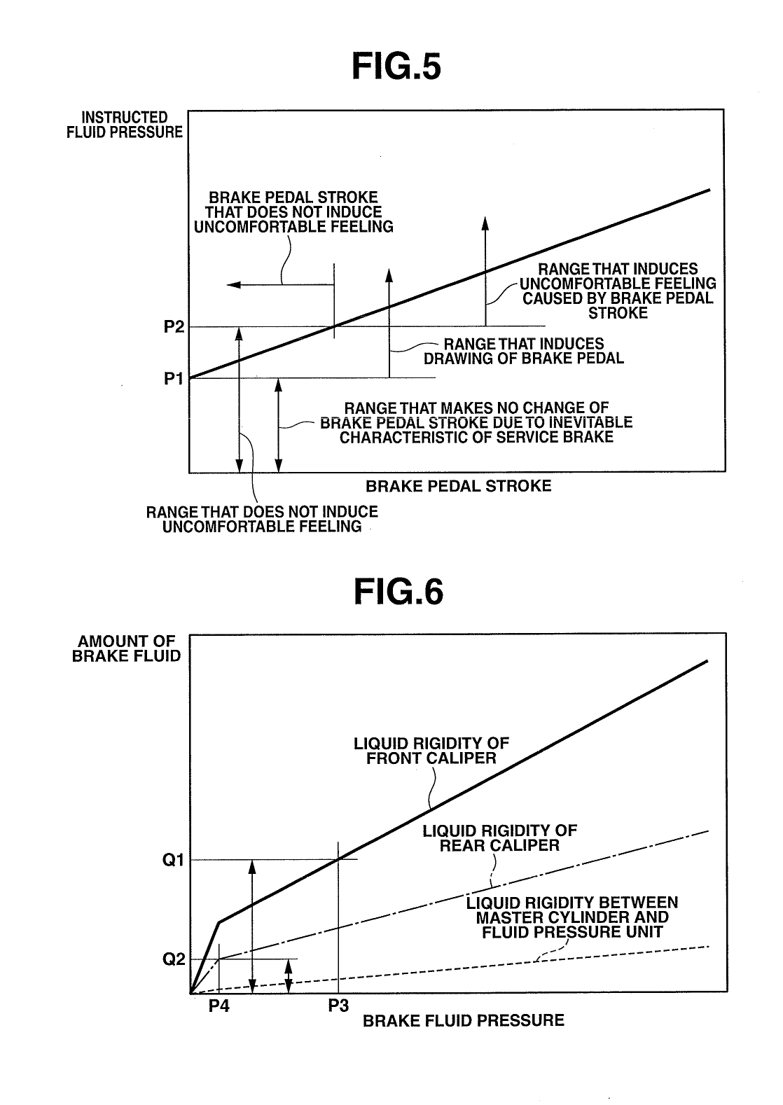

FIG. 5 is a graph showing a relation between an instructed fluid pressure (viz., target master cylinder fluid pressure) for the electric booster 22 and a brake pedal stroke. As is seen from by this graph, until the instructed fluid pressure increases to level P1, no stroke of the brake pedal 20 appears. However, when the instructed fluid pressure exceeds level P1, stroke of the brake pedal 20 appears. However, even when the brake pedal 20 is subjected to the stroke, a driver can be protected from feeling uncomfortable if the stroke amount is very small. However, if the instructed fluid pressure exceeds level P2, the degree of the brake pedal stroke becomes large, which provides the driver with uncomfortable feeling. In other words, when, with the required brake cylinder fluid pressure being high, an attempt is made for increasing the brake cylinder fluid pressure by the electric booster 22, it often happens that the stroke of the brake pedal 20 causes the driver to feel uncomfortable.

In view of the above, the following measures may be thought out in which the brake fluid pressure generated by the electric booster 22 is suitably controlled. However, in this case, there is a high possibility that reduction or shortage of the brake cylinder fluid pressure appears under the control.

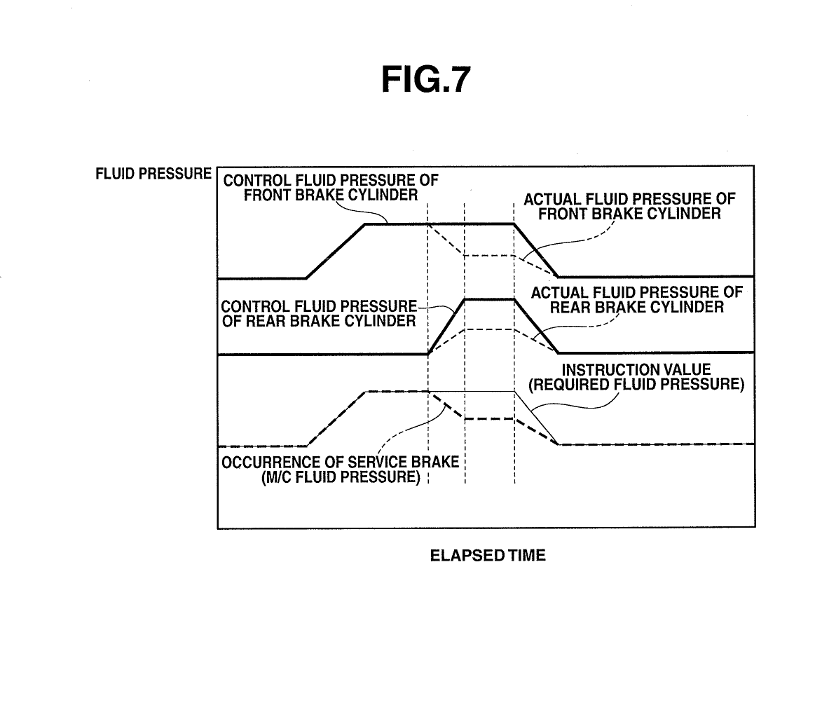

FIG. 6 is a graph showing a relation between a brake fluid pressure in one of primary and secondary brake systems and a brake fluid amount in the first embodiment. FIG. 7 is a time chart showing changes of a brake cylinder fluid pressure, a brake cylinder fluid pressure for a rear road wheel and a master cylinder fluid pressure with respect to an elapsed time in the first embodiment.

As is seen from the graph of FIG. 6, at first, the brake cylinder fluid pressure for a front road wheel is increased to level P3. In this case, the brake fluid amount led to the brake cylinder of the front road wheel is Q1. After the brake cylinder fluid pressure for the front road wheel is increased, instruction is is issued for increasing the brake cylinder fluid pressure for a rear road wheel to level P4. In this case, the amount of brake fluid amount required by the brake cylinder for the rear wheel is Q2, and the amount of brake fluid remaining in the fluid passage between the master cylinder 21 and the fluid pressure control unit 3 is smaller than the amount Q2.

In the following, the manner of the brake cylinder fluid pressure for the front road wheel, that for the rear road wheel and that for the master cylinder fluid pressure will be described with the aid of the graph of FIG. 7. As is seen from the graph of FIG. 7, when the brake cylinder fluid pressure for the rear road wheel is increased after the brake cylinder fluid pressure for the front road wheel is increased, the brake fluid in the master cylinder 21 is led into the brake cylinder 42 for the rear road wheel, and thus, the master cylinder fluid pressure is reduced. Upon this pressure reduction of the master cylinder, the fluid pressure in an upstream area of the brake cylinder 42 for the front road wheel is reduced, and the brake fluid in the brake cylinder 42 for the front road wheel is led into the brake cylinder 42 for the rear road wheel causing reduction in the fluid pressure in the brake cylinder for the front road wheel. Since the master cylinder fluid pressure has been reduced, it is impossible to sufficiently increase the brake cylinder pressure for the rear road wheel.

Accordingly, in the first embodiment of the present invention, in accordance with a required brake cylinder fluid pressure, the brake fluid pressure is increased by the electric booster 22, and the brake fluid pressure thus increased by the electric booster 22 is increased by the pumps 31P and 31S.

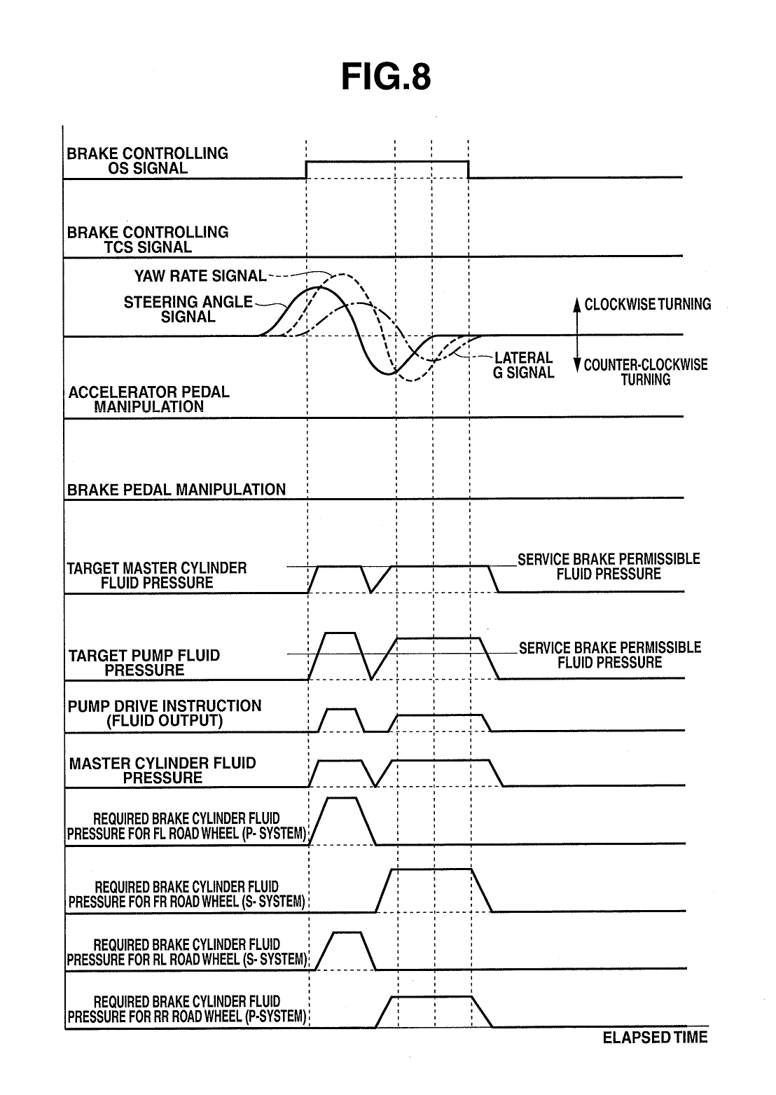

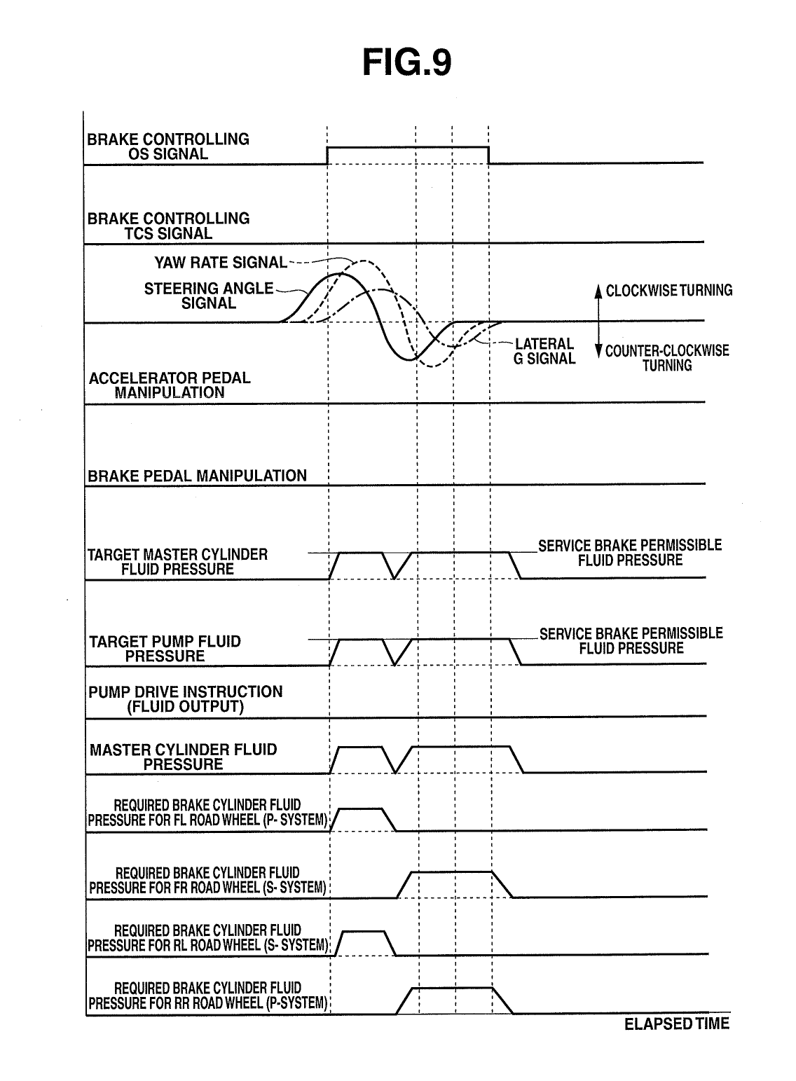

FIGS. 8 and 9 are time charts depicting operation manner of the brake fluid pressure control system of the first embodiment at the time when the system is carrying out the vehicle behavior stabilizing control (or oversteer suppressing control). The time is chart of FIG. 8 depicts the operation manner when the required brake cylinder fluid pressure is high, and the time chart of FIG. 9 depicts the operation manner when the required brake cylinder fluid pressure is low.

As is seen from the time chart of FIG. 8, when the required brake cylinder fluid pressure is high, the electric booster 22 is operated while setting the target master cylinder fluid pressure at the service brake permissible fluid pressure and at the same time the pumps 31P are 31S are driven while setting the target pump fluid pressure at the maximum required brake cylinder fluid pressure. With this, a fluid pressure that would not be sufficiently supplied by the master cylinder fluid pressure can be increased or boosted.

While, as is seen from the time chart of FIG. 9, when the required brake cylinder fluid pressure is low, the electric booster 22 is operated while setting the target master cylinder fluid pressure at the maximum required brake cylinder fluid pressure and at the same time, the pumps 31P and 31S are stopped while setting the target pump fluid pressure at the maximum required brake cylinder fluid pressure like the target master cylinder fluid pressure.

With this, operation of the electric booster 22 is made within a range that suppresses the brake pedal 20 from making a stroke and a shortage of fluid pressure caused by non-operation of the electric booster 22 can be compensated by operation of the pumps 31P and 31S. Thus, uncomfortable feeling applied to the driver when the brake pedal 20 makes the stroke is suppressed and the operation of the pumps 31P and 31S is controlled or restrained, and thus, the pumps 31P and 31S and the electric motor 32 can be made small in size, and at the same time noises produced by such devices can be reduced.

In the first embodiment, the target master cylinder fluid pressure is set in accordance with the maximum one of the required brake cylinder fluid pressures. Accordingly, increasing the brake fluid pressure can be made as much as possible by the electric booster 22, and thus, operation of the pumps 31P and 31S can be controlled.

Furthermore, in the first embodiment, for holding the fluid pressure, the pressure increasing valve 35FL, 35RR, 35FR or 35RL that is associated with the brake cylinder that has the fluid pressure reached the required brake cylinder fluid pressure is closed. With this, load of the electric booster 22 is reduced.

Furthermore, in the first embodiment, for preparing the required brake cylinder fluid pressure, the electric booster 22 is forced to operate until the time when the brake fluid pressure increases to the service brake permissible fluid pressure Th_P, and after the fluid pressure arrives at the service brake permissible fluid pressure Th_P, the brake fluid pressure increased by the electric booster 22 is increased or boosted by the pump 31P or 31S. With this, the brake cylinder fluid pressure is controlled to the required brake cylinder fluid pressure. Accordingly, uncomfortable feeling that would be applied to a driver due to stroke of the brake pedal 20 can be suppressed or at least minimized and at the same time, operation of the pumps 31P and 31S can be suppressed or at least minimized. It is to be noted that the service brake permissible fluid pressure Th_P is set to the fluid pressure P2 in FIG. 5.

Furthermore, in the first embodiment, until the time when the amount of brake fluid led to the side of the brake cylinders 42RL, 42FR, 42FL and 42RR by the electric booster 22 increases to the service brake permissible fluid amount, the fluid pressure increase is effected by the electric booster 22, and after the amount arrives at the service brake permissible fluid amount, the brake fluid pressure prepared by the electric booster 22 is increased or boosted by the pumps 31P and 31S, so that the brake fluid pressure is controlled to the required brake cylinder fluid pressure. With this, uncomfortable feeling that would be applied to the driver due to stroke of the brake pedal 20 can be restrained and at the same time operation of the pumps 31P and 31S can be restrained.

In the following, advantages given by the first embodiment will be described with the aid of the drawings.

(1) In the first embodiment, there is provided a brake fluid pressure control system of a motor vehicle, which comprises a master cylinder 21 that produces a fluid pressure when a brake pedal is depressed by a driver, an electric booster 22 (or upstream side brake fluid pressure controlling device) that boosts the fluid pressure in the master cylinder 21 when energized, pumps 31P and 31S, control valves, a fluid pressure control unit 3 (or downstream side brake fluid pressure controlling device) that controls a fluid pressure flow from the master cylinder 21 to each of the brake cylinders 42RL, 42FR, 42FL and 42RR of four road wheels with the aid of the pumps 31P and 31S and the valves, and a brake controller 6 that controls the upstream and downstream side brake fluid pressure controlling devices, in which the brake controller 6 comprises a required brake cylinder fluid pressure calculating section 63 that calculates a required brake cylinder fluid pressure for each brake cylinder 42RL, 42FR, 42FL or 42RR in accordance with a behavior of an associated motor vehicle, a service brake controller 60 (or first road wheel brake cylinder fluid pressure producing section) that controls or operates a service brake 2 (or electric booster 22) for obtaining the required brake cylinder fluid pressure thus calculated, and a brake fluid pressure controller 62 (or second road wheel brake cylinder fluid pressure producing section) that, with the work of the fluid pressure control unit 3 (or pumps 31P and 31S), increases the brake cylinder fluid pressure produced by the service brake controller 60.

Accordingly, the electric booster 22 is controlled to make is actual boosting to the brake fluid pressure in a range wherein the brake pedal 20 is not depressed, and the pumps 31P and 31S are controlled to increase the brake fluid pressure by a degree that would be short when increasing of the brake fluid pressure is made by the electric booster 22. Accordingly, uncomfortable feeling applied to the driver when the brake pedal 20 makes the stroke is suppressed and the operation of the pumps 31P and 31S is controlled or restrained. Thus, the pumps 31P and 31S and the electric motor 32 cam be made small in size, and at the same time, noises produced by such devices can be reduced.

(2) The required brake cylinder fluid pressure calculating section 63 calculates the required brake cylinder fluid pressures for the four brake cylinders 42RL, 42FR, 42FL and 42RR, and the service brake controller 60 is equipped with a target master cylinder fluid pressure calculating section 60a that calculates a target master cylinder fluid pressure from the maximum one of the calculated required brake cylinder fluid pressures, and the electric booster 22 is so operated as to cause the master cylinder pressure to show the target master cylinder fluid pressure.

Accordingly, increase of the brake fluid pressure is made by the electric booster 22 as far as the booster 22 can do it, so that actual operation of the pumps 31P and 31S can be restrained.

(3) The actual brake cylinder fluid pressure calculating section 64 that calculates the fluid pressure in each brake cylinder 42RL, 42FR, 42FL or 42RR is further provided. When the calculated actual brake cylinder fluid pressure shows the calculated required brake cylinder fluid pressure, the brake controller 6 holds the brake cylinder fluid pressure with the aid of the control valves of the fluid pressure control unit 3.

Accordingly, a load of the electric booster 22 can be reduced.

(4) Due to the brake controller 6, until the time when the required brake cylinder fluid pressure increases to a predetermined brake cylinder fluid pressure (or service brake permissible fluid pressure), the electric booster 22 is operated by the instruction from the service brake controller 60, and when the required brake cylinder fluid pressure exceeds the predetermined brake cylinder fluid pressure, the fluid pressure control unit 3 is actuated by the brake fluid pressure controller 62 while keeping the operation of the electric booster 22 by the service brake controller 60, so that the required brake cylinder fluid pressure is obtained.

Accordingly, uncomfortable feeling that would be applied to a driver due to stoke of the brake pedal 20 can be suppressed or at least minimized and at the same time, operation of the pumps 31P and 31S can be suppressed or at least minimized.

(5) For obtaining the required brake cylinder fluid pressure, the brake controller 6 carries out the following operation. That is, until the time when a predetermined amount of brake fluid (viz., service brake permissible fluid amount) is led into a predetermined brake cylinder, the operation of the electric booster 22 is made by the instruction from the brake fluid pressure controller 62, and when the brake fluid for the brake cylinder exceeds the predetermined amount, the fluid pressure control unit 3 is operated by the instruction from the brake fluid pressure controller 62 while keeping the operation of the electric booster 22 by the service brake controller 60, so that the required brake cylinder fluid pressure is obtained.

Accordingly, uncomfortable feeling that would be applied to a driver due to stroke of the brake pedal 20 can be suppressed or at least minimized and at the same time, operation of the pumps 31P and 31S can be suppressed or at least minimized.

### Second Embodiment (E-2)

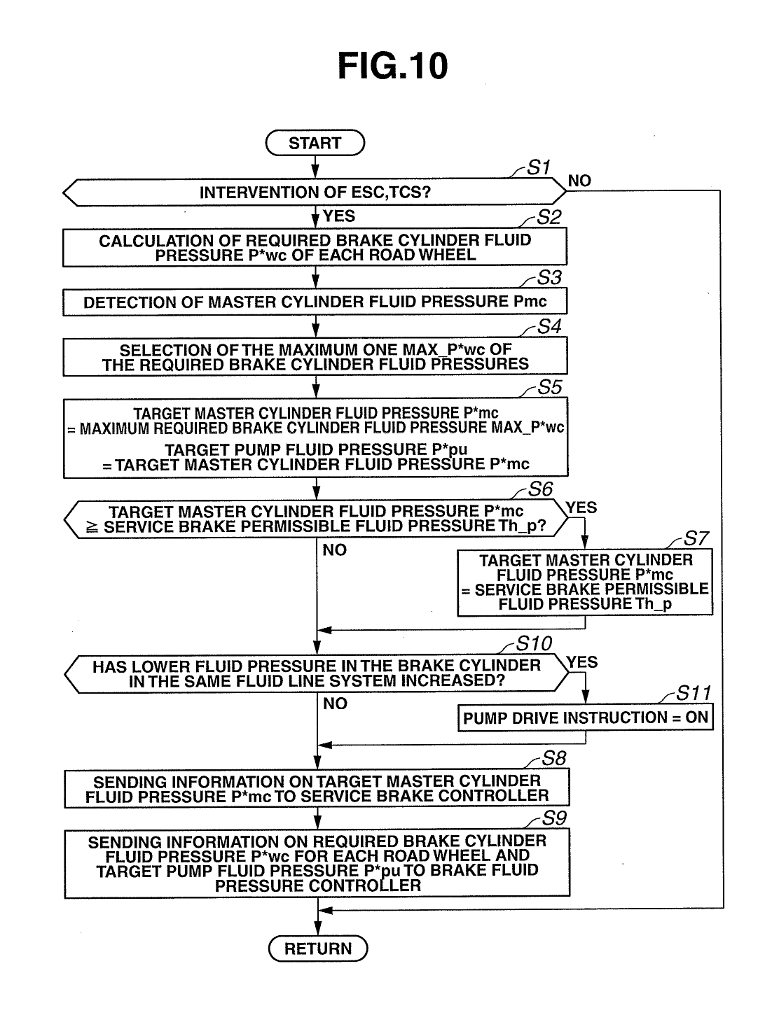

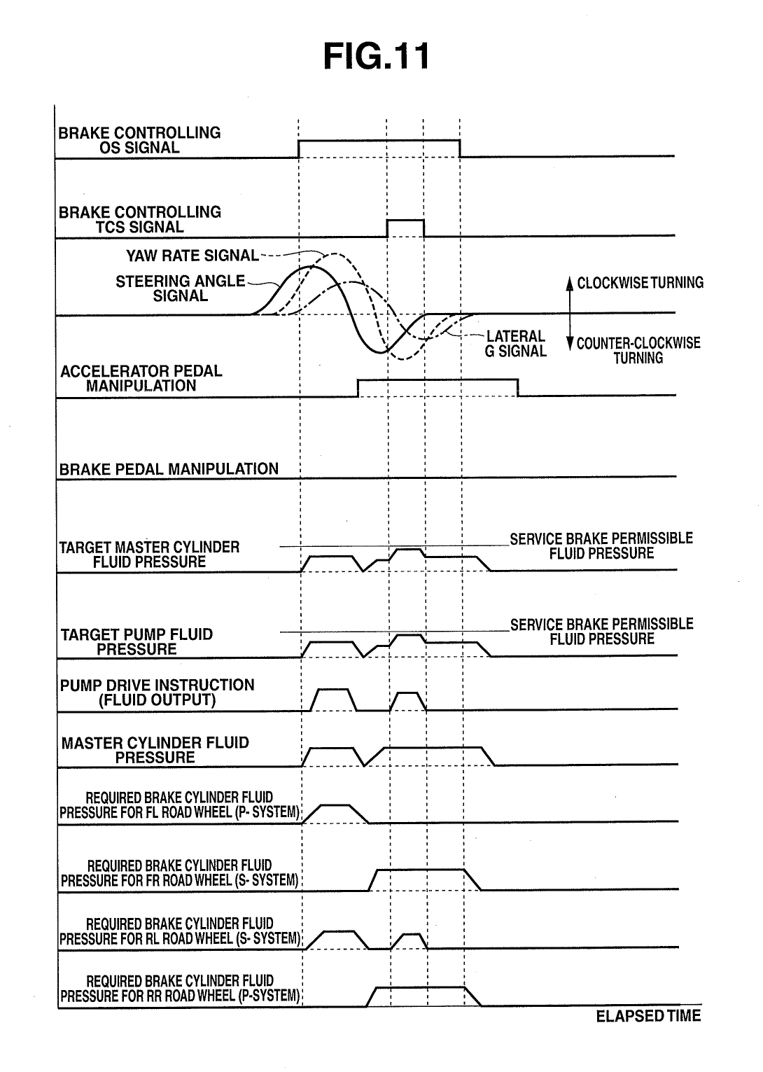

In the following, a second embodiment E-2 of the present invention will be described with reference to FIGS. 10 and 11.

In the second embodiment, measures are employed for is solving weak points that would appear at the time when during a first running support brake control, a second running support brake control intervenes in the first running support brake control, like a case in which during an oversteer suppressing control, TCS control intervenes in the oversteer suppressing control.

Referring to FIG. 10, there is shown a flowchart depicting programmed operation steps executed in the second embodiment.

As will be described in the following, in the second embodiment, new operation steps S10 and S11 are added to the flowchart of the above-mentioned first embodiment at a position between step S7 and S8 of the first embodiment.

Since the operation steps are substantially the same as those of the first embodiment except the new steps Figs. S10 and S11, the following explanation will be directed to only the new steps S10 and S11 for simplification of the description.

That is, at step S10, judgment is carried out as to whether or not the fluid pressure in the brake cylinder showing a lower level than that in the other brake cylinder in the same fluid line system has increased. If YES, that is, when it is judged that the fluid pressure in the brake cylinder has increased, the operation flow goes to step S11, and if NO, that is, when it is judged that the fluid pressure in the brake cylinder has not increased, the operation flow goes to step S8.

By these steps, it can be realized that during the time when a brake cylinder fluid pressure for a front wheel is being produced under the oversteer suppressing control, necessity or unnecessity of producing a brake cylinder fluid pressure for a rear wheel by TCS control can be judged.

At step S11, the pumps 31P and 31S are driven and then the operation flow goes to step S8. With this, even when the target master cylinder fluid pressure P*mc is smaller than the service brake permissible fluid pressure Th_P, the pumps 31P and 31S are forced to run.

In the following, operation of the second embodiment will be described.

When it is intended to increase the brake cylinder fluid pressure for a rear wheel after the brake cylinder fluid pressure for a front wheel is increased, the brake fluid in the brake cylinder 42FR or 42FL for the front wheel is forced to flow toward the brake cylinder 42RR or 42RL for the rear wheel, which tends to bring about an instant reduction in fluid pressure in the brake cylinder for the front wheel.

Accordingly, in the second embodiment, when it is intended to increase the lower pressure side brake cylinder pressure in the same fluid line system, the pumps 31P and 31S are forced to run even if the target master cylinder fluid pressure is smaller than the service brake permissible fluid pressure.

FIG. 11 is a time chart depicting operation manner of the brake fluid pressure control system of the second embodiment at the time when the vehicle behavior stabilizing control is carried out. More specifically, FIG. 11 shows operation manner of the second embodiment at the time when, under the oversteer suppressing control, an accelerator pedal is depressed by a driver causing TCS control to intervene in the oversteer suppressing control. Just before the time when TCS control intervenes, the required fluid pressure for the brake cylinder 42RL of the rear-left road wheel shows 0 (zero). However, once TCS control intervenes, the required fluid pressure for the brake cylinder 42RL of the rear-left road wheel is increased. Upon this, the pumps 31P and 31S are forced to run, so that the fluid pressure in the brake cylinder 42RL of the rear-left road wheel can be increased without reducing the fluid pressure in the brake cylinder 42FR of the front-right road wheel of the same fluid line system.

In the following, advantages of the second embodiment will be described.

(6) Due to control by the brake controller 6, when the fluid pressure in the brake cylinder that shows a lower level than that of the brake cylinder of the same fluid line system, the pumps 31P and 31S are forced to run even when the target master cylinder fluid pressure is smaller than the service brake permissible fluid pressure.

Accordingly, the brake cylinder fluid pressure of the lower pressure side can be increased without reducing the brake cylinder fluid pressure of the higher pressure side.

### Third Embodiment (E-3)

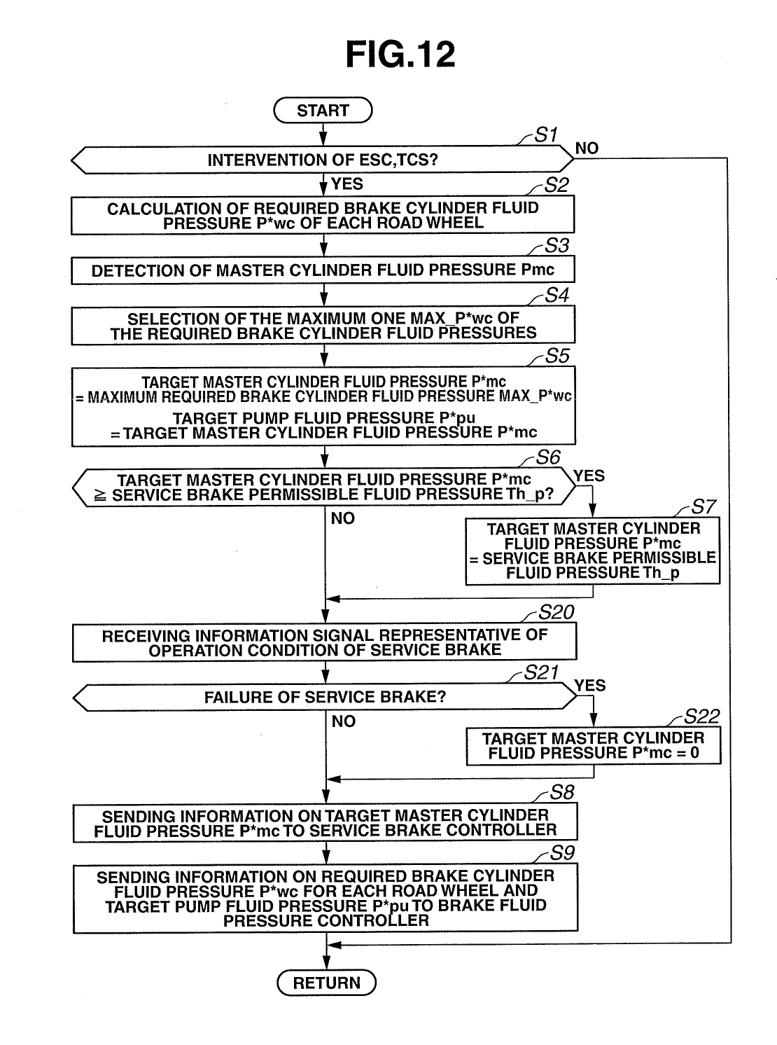

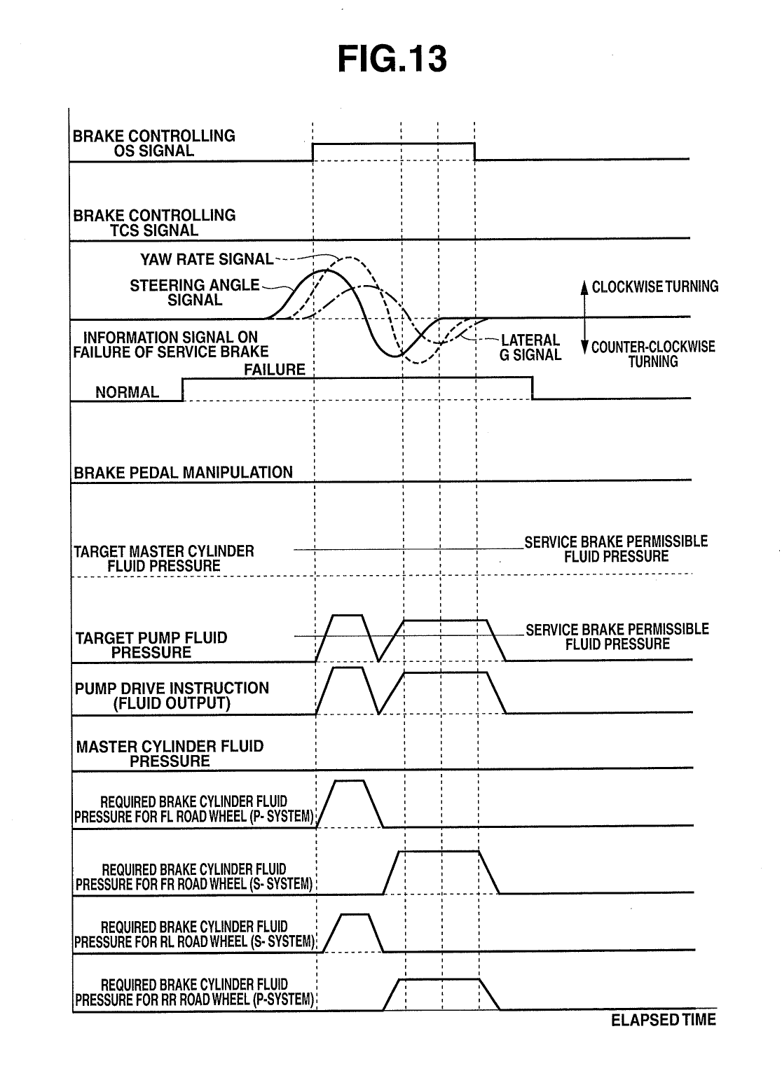

In the following, a third embodiment E-3 of the present invention will be described with reference to FIGS. 12 and 13.

In the third embodiment, measures are employed for solving weak points that would appear at the time when, due to failure of the electric booster 22, the service brake 2 becomes out of order.

Referring to FIG. 12, there is shown a flowchart depicting programmed operation steps executed in the third embodiment.

As will be described in the following, in the third embodiment, new operation steps S20, S21 and S22 are added to the flowchart of the above-mentioned first embodiment at a position between step S7 and step S8 of the first embodiment.

Since the operation steps are substantially the same as those of the first embodiment except the new steps S20, S21 and S22, the following explanation will be directed to only the new operation steps S20, S21 and S22 for simplification of the description.

That is, at step S20, information signal on operation condition of the service brake 2 is inputted from the service brake failure detecting section 70, and then the operation flow goes to step S21.

At step S21, by processing the information, judgment is is carried out as to whether the electric booster 22 is out of order or not. If YES, that is, when it is judged that the electric booster 22 is out of order, the operation flow goes to step S22, and if NO, that is, when it is judged that the electric booster 22 is not out of order, the operation flow goes to step S8.

At step S22, the target master cylinder fluid pressure P*mc is set to 0 (zero), and then the operation flow goes to step S8.

In the following, operation of the third embodiment will be described.

When the electric booster 22 is out of order, production of normal brake fluid pressure is not expected from the service brake 2. Thus, in the third embodiment, when the electric booster 22 is out of order, the target master cylinder fluid pressure is set to 0 (zero), and the pumps 31P and 31S are driven to ensure the fluid pressure for the brake cylinders of the four road wheels. At step S5, the target pump fluid pressure P*pu is set to the target master cylinder fluid pressure P*mc that is calculated in accordance with the required brake cylinder fluid pressure P*wc for each road wheel. It is to be noted that the target master cylinder fluid pressure P*mc is set to 0 (zero) at step S22. That is, since after setting of the target pump fluid pressure P*pu, the target master cylinder fluid pressure P*mc is set to 0 (zero) at step S22, a fluid pressure corresponding to originally set target master cylinder fluid pressure P*mc is ensured by the pumps 31P and 31S.

FIG. 13 is a time chart depicting operation manner of the brake fluid pressure control system of the third embodiment at the time when the vehicle behavior stabilizing control is carried out. More specifically, the time chart shows a case in which the oversteer suppressing control intervenes in the vehicle behavior stabilizing control. As is seen from the time chart, when the electric booster 22 becomes out of order, the target master cylinder fluid pressure is set to 0 (zero) for making the electric is booster 22 deenergized. While, the pumps 31P and 31S are driven for ensuring the fluid pressure for the brake cylinders of the road wheels.

In the following, advantages of the third embodiment will be described.

(7) When a failure of the electric booster 22 is detected by the service brake failure detecting section 70, the brake fluid pressure controller 62 of the brake fluid pressure controller 6 controls the pumps 31P and 31S to run, so that a fluid pressure corresponding to the target master cylinder fluid pressure is produced.

Even if the electric booster 22 is out of order, the fluid pressure for the brake cylinders of the road wheels is ensured by the operation of the pumps 31P and 31S.

### Fourth Embodiment (E-4)

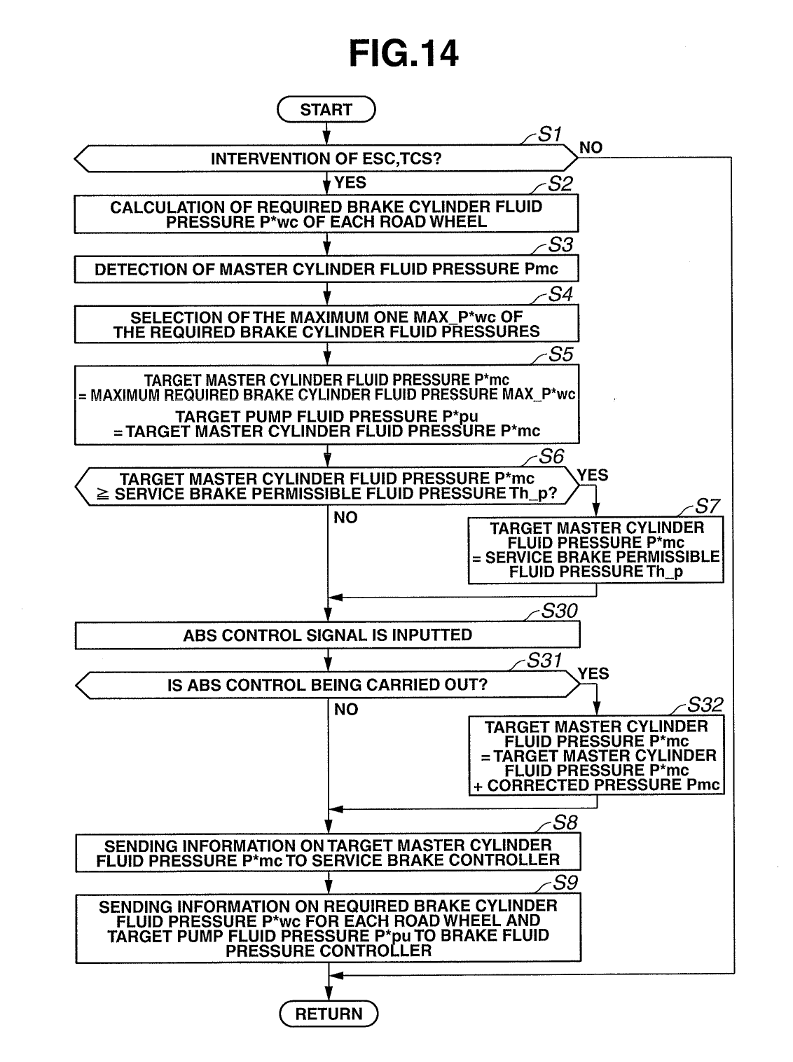

In the following, a fourth embodiment E-4 of the present invention will be described with reference to FIGS. 14, 15 and 16.

In the fourth embodiment, measures are employed for solving weak points that would appear when ABS control is carried out.

Referring to FIG. 14, there is shown a flowchart depicting programmed operation steps executed in the fourth embodiment.

In the fourth embodiment, new operation steps S30, S31 and S32 are added to the flowchart of the above-mentioned first embodiment at a position between step S7 and step S8 of the first embodiment.

Since the operation steps are substantially the same as those of the first embodiment except the new steps S30, S31 and S32, the following explanation will be directed to only the new operation steps S30, S31 and S32 for simplification of the description.

At step S30, a control signal for ABS is inputted, and then the operation flow goes to step S31.

At step S31, judgment is carried out as to whether ABS control is being carried out or not. If YES, that is, when it is judged that ABS control is being carried out, the operation flow goes to step S32, and if NO, that is, when it is judged that ABS control is not being carried out, the operation flow goes to step S8.

At step S32, a variation ΔPmc of the master cylinder fluid pressure induced by the increasing/decreasing fluid pressure control for the brake cylinder fluid pressure is calculated, and the calculated variation ΔPmc is added to the target master cylinder fluid pressure P*mc set at step S5 to update the target master cylinder fluid pressure P*mc, and then the operation flow goes to step S8. More specifically, in case of increasing the brake cylinder fluid pressure, the variation ΔPmc is so calculated as to increase the master cylinder fluid pressure, and in case of reducing the brake cylinder fluid pressure, the variation ΔPmc is so calculated as to reduce the master cylinder fluid pressure.

In the following, operation of the fourth embodiment will be described.

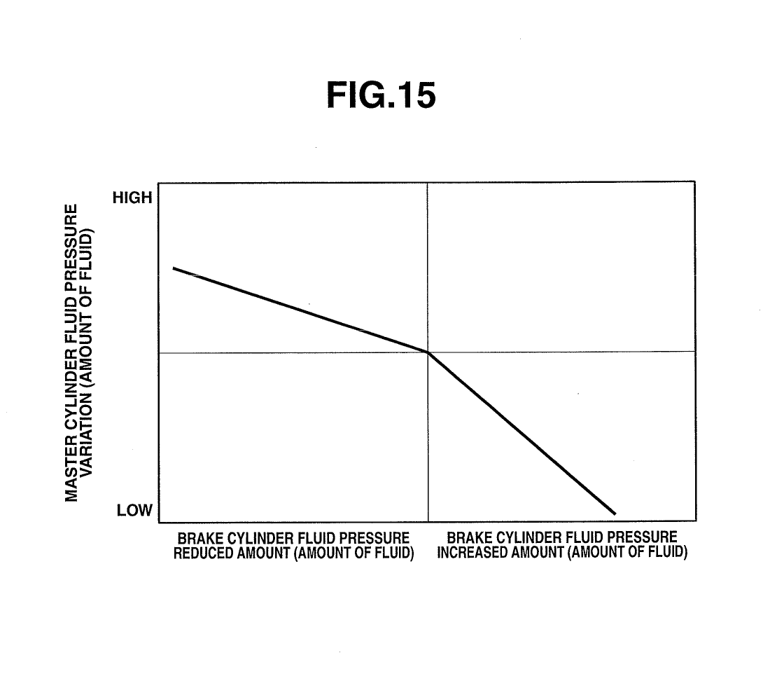

FIG. 15 is a graph showing a relation between the brake cylinder fluid pressure and the master cylinder fluid pressure at the time when ABS control is being carried out in the fourth embodiment. As shown in this graph, in case of reducing the brake cylinder fluid pressure, the brake fluid is returned to the master cylinder 21 by the operation of the pumps 31P and 31S, and thus, the master cylinder fluid pressure is increased. While, in case of increasing the brake cylinder fluid pressure, the brake fluid in the master cylinder 21 is led to the brake cylinder, and thus, the master cylinder fluid pressure is reduced. With this operation, the brake pedal 20 kept depressed by a driver under ABS control is subjected to a vibration.

Accordingly, in the fourth embodiment, in case of increasing the brake cylinder fluid pressure under ABS control, the electric booster 22 is so controlled as to increase the master cylinder fluid pressure, and in case of reducing the brake cylinder fluid pressure, the electric booster 22 is so controlled as to reduce the master cylinder fluid pressure.

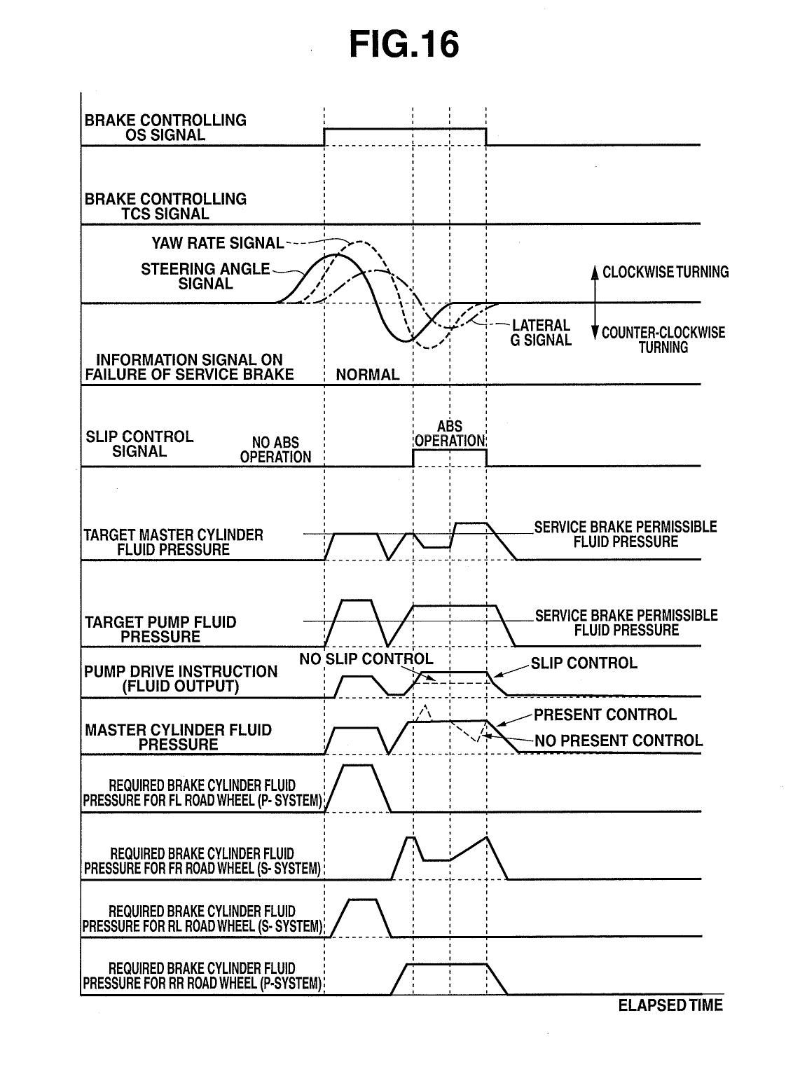

FIG. 16 is a time chart depicting operation manner of the brake fluid pressure control system of the fourth embodiment under the vehicle behavior stabilizing control. More specifically, the time chart of FIG. 16 shows a case in which under the oversteer suppressing control as the vehicle behavior stabilizing control, ABS control is actually applied to the front-right road wheel. As is seen from the time chart of this drawing, when, due to the actual application of ABS control, the fluid pressure in the brake cylinder of the front-right road wheel is reduced, the target master cylinder fluid pressure is also reduced. With this, increase of the master cylinder fluid pressure is suppressed. Furthermore, when the fluid pressure in the brake cylinder of the front-right road wheel is increased, the target master cylinder fluid pressure is also increased. With this, decrease of the master cylinder fluid pressure is suppressed.

Due to the above-mentioned increase or decrease in the target master cylinder fluid pressure, undesired vibration of the brake pedal 20 can be suppressed or at least minimized. Furthermore, since the master cylinder fluid pressure is reduced at the time of reduction of the fluid pressure in the brake cylinder, the load applied to the pumps 31P and 31S at the time of returning the brake fluid to the master cylinder 21 can be reduced.

In the following, advantages of the fourth embodiment will be described.

(8) In the fourth embodiment, the master cylinder fluid pressure sensor 25 (or master cylinder fluid pressure calculating section) that senses or calculates the master cylinder fluid pressure, the ABS/TCS/ESC/HDC (Anti-lock Brake System/Traction Control System/Electronic Stability Control/Hill Descent Control) controller 61 that senses a possibility of lock of any one of road wheels and increases or decreases the fluid pressure in the brake cylinder of the lock-trend road wheel and the brake controller 6 are mainly operated. That is, when, during operation of the electric booster 22, the calculated master cylinder fluid pressure is increased by the increase/decrease in the fluid pressure in the brake cylinder due to operation of the ABS/TCS/ESC/HDC controller 61, the service brake controller 60 reduces the master cylinder fluid pressure, and when the master cylinder fluid pressure is lowered, the service brake controller 60 increases the master cylinder fluid pressure.

Accordingly, undesired vibration of the brake pedal 20 that would be produced under ABS control can be suppressed. Furthermore, since the master cylinder fluid pressure is reduced at the time of pressure reduction, the load applied to the pumps 31P and 31S at the time of returning the brake fluid to the master cylinder 21 can be reduced.

### Fifth Embodiment (E-5)

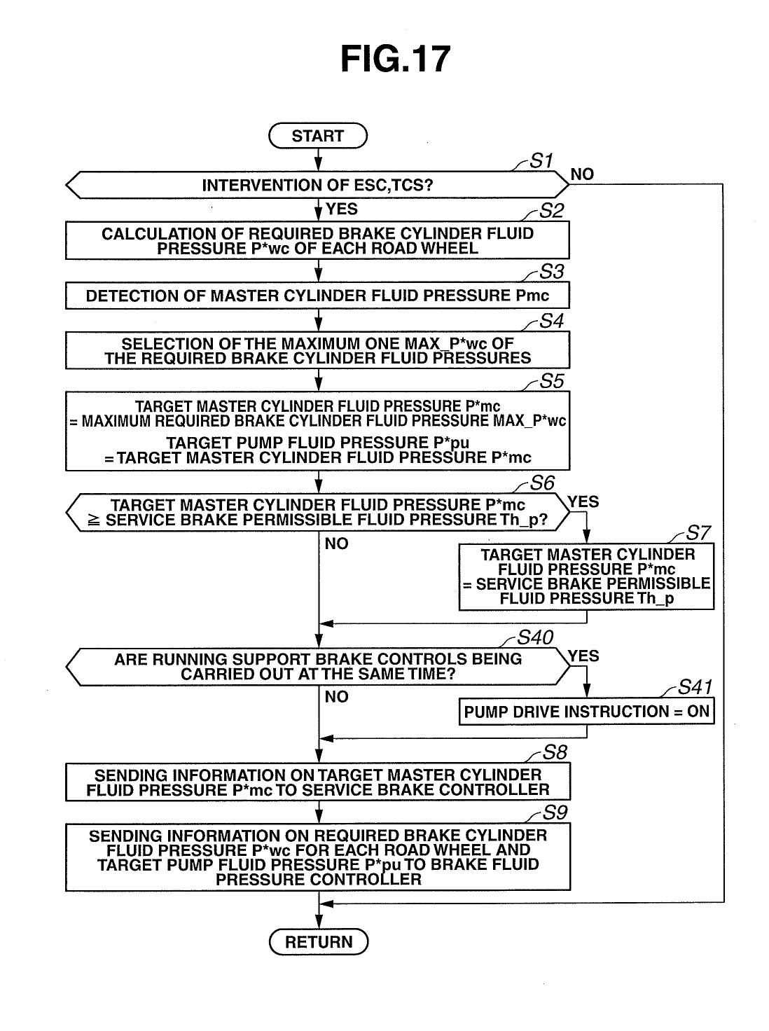

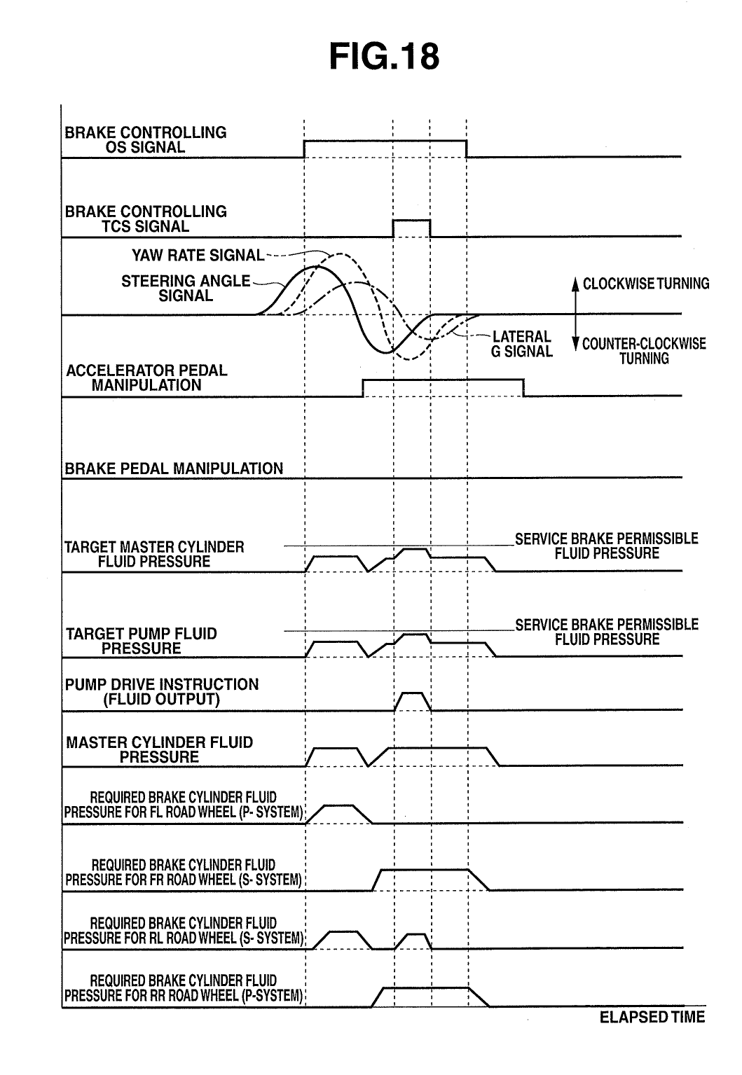

In the following, a fifth embodiment E-5 of the present invention will be described with reference to FIGS. 17 and 18.

In the fifth embodiment, measures are employed for solving weak points that would appear when a plurality of running support brake controls are carried out.

Referring to FIG. 17, there is shown a flowchart depicting programmed operation steps executed in the fifth embodiment.

In the fifth embodiment, new operation steps S40 and S41 are added to the flowchart of the above-mentioned first embodiment at a position between step S7 and step S8 of the first embodiment.

Since the operation steps are substantially the same as those of the first embodiment except the new steps S40 and S41, the following explanation will be directed to only the new steps S40 and S41 for simplification of the description.

At step S40, judgment is carried out as to whether a plurality of running support brake controls are operated or not. If YES, that is, when it is judged that the plurality of running support brake controls are operated, the operation flow goes to step S41, and if NO, that is, when it is judged that a single running support brake control is only operated, the operation flow goes to step S8.

The condition in which a plurality of running support brake controls are operated means for example a condition in which under the oversteer suppressing control, TCS control intervenes.

At step S41, the pumps 31P and 31S are driven and then the operation flow goes to step S8. That is, even when the target master cylinder fluid pressure P*mc is smaller than the service brake permissible fluid pressure Th_P, the pumps 31P and 31S are forced to run.

In the following, operation of the brake fluid pressure control system of the fifth embodiment will be described.

When a plurality of running support brake controls are operated, the amount of brake fluid led to the brake cylinders 42RL, 42FR, 42FL and 42RR is increased. Actually, such increased amount of brake fluid is not sufficiently prepared by the electric booster 22 or the pumps 31P and 31S, inducing the possibility of shortage of the brake cylinder fluid pressure.

Accordingly, in the fifth embodiment, when it is judged that, due to usage of a plurality of vehicle behavior stabilizing controls, shortage of brake cylinder fluid pressure may occur, the pumps 31P and 31S are forced to run even when the target master cylinder fluid pressure is smaller than the service brake permissible fluid pressure.

FIG. 18 is a time chart depicting operation manner of the brake fluid pressure control system of the fifth embodiment under the vehicle behavior stabilizing control. More specifically, the time chart of FIG. 18 shows a case in which under the oversteer suppressing control, TCS control intervenes due to depression of an accelerator pedal by a driver. As is seen from the time chart, when only the oversteer suppressing control is carried out, the pumps 31P and 31S are kept stopped. However, when, under the oversteer suppressing control, TCS control is started, the pumps 31P and 31S are driven. With this, shortage of the brake cylinder fluid pressure is prevented while restraining operation of the pumps 31P and 31S.

In the following, advantages of the fifth embodiment will be described.

(9) In this fifth embodiment, the brake fluid pressure control 62 that carries out the vehicle behavior control in accordance by increasing or decreasing the brake cylinder fluid pressure with the aid of the pumps 31P and 31S and the brake controller 6 are mainly operated. That is, when, with the brake cylinder fluid pressure being smaller than a predetermined fluid pressure (viz., service brake permissible fluid pressure), the brake fluid pressure controller 62 judges that any one of the brake cylinders is subjected to a fluid pressure shortage, the fluid pressure of the judged brake cylinder is increased by driving the pumps 31P and 31S. Thus, shortage of the brake cylinder fluid pressure is eliminated while restraining operation of the pumps 31P and 31S.

### Sixth Embodiment (E-6)

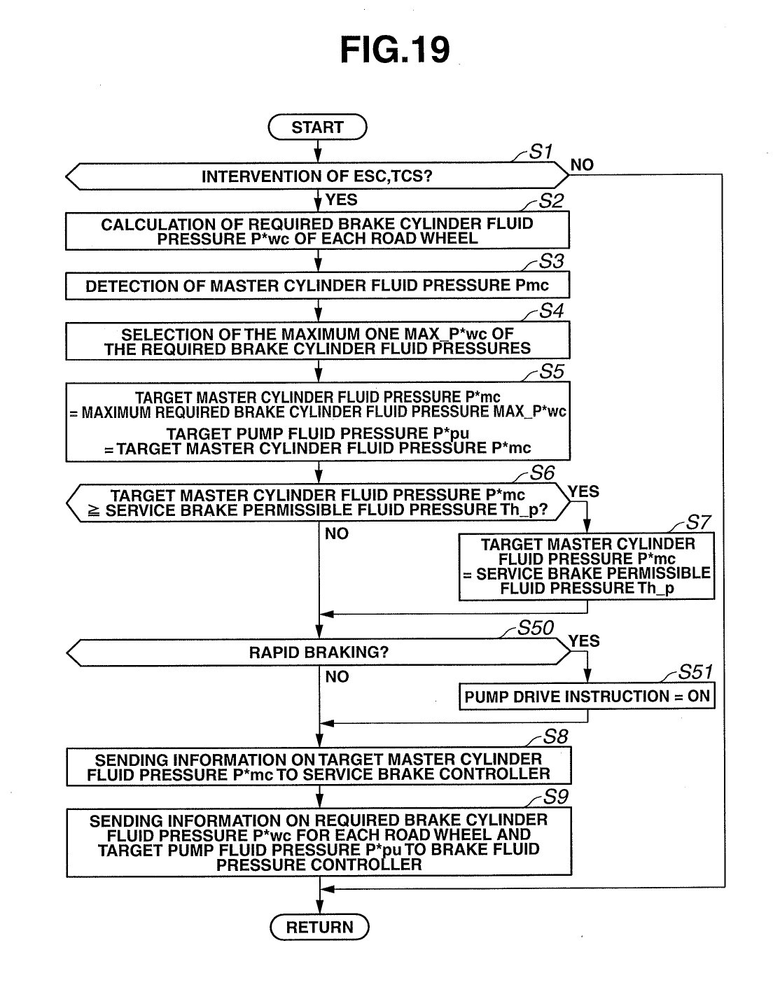

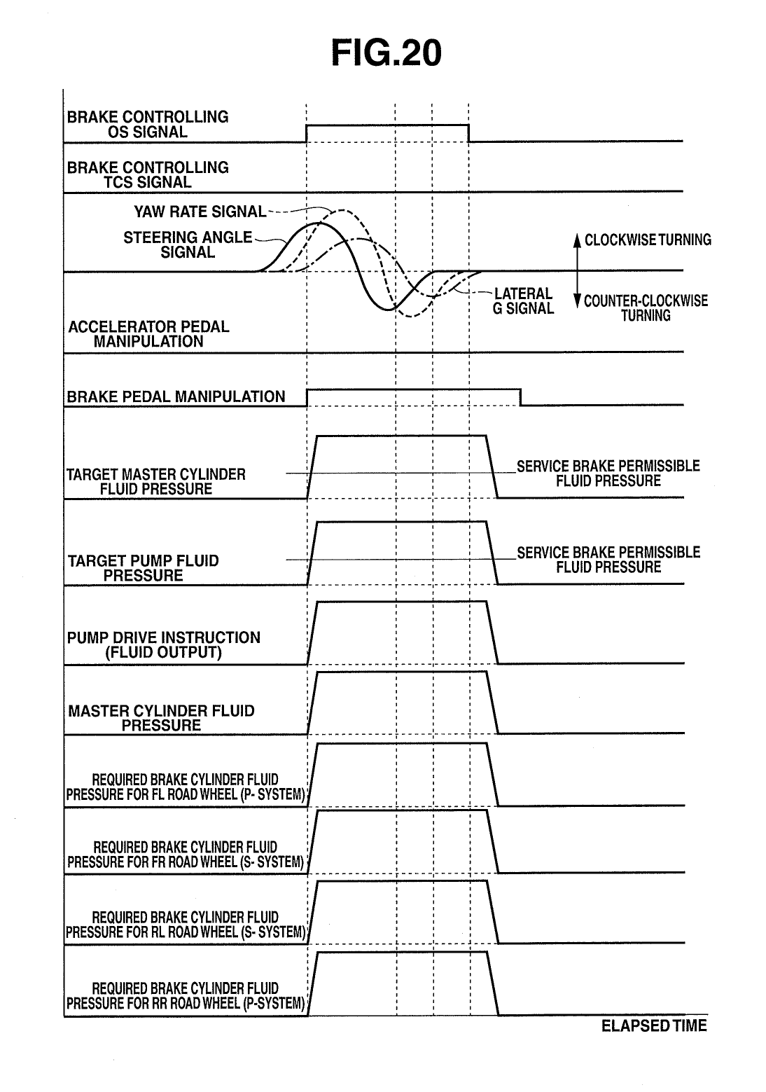

In the following, a sixth embodiment E-6 of the present invention will be described with reference to FIGS. 19 and 20.

In the sixth embodiment, measurements are employed for solving weak points that would appear upon a rapid braking.

Referring to FIG. 19, there is shown a flowchart depicting is programmed operation steps executed in the fifth embodiment.

In the sixth embodiment, new operation steps S50 and S51 are added to the flowchart of the above-mentioned first embodiment at a position between step S7 and step S8 of the first embodiment.

Since the operation steps are substantially the same as those of the first embodiment except the new steps S50 and S51, the following explanation will be directed to only the new steps S50 and S51 for simplification of the description.

At step S50, judgment is carried out as to whether a rapid braking takes place or not. If YES, that is, when it is judged that a rapid braking takes place, the operation flow goes to step S51, and if NO, that is, when it is judged that a rapid braking does not take place, the operation flow goes to step S8.

The rapid braking can be determined by sensing that the depressing speed of the brake pedal 20 is higher than a predetermined speed and/or sensing that the depressing amount of the brake pedal 20 is greater than a predetermined amount.

At step S51, the pumps 31P and 31S are driven and the operation flow goes to step S8. That is, even when the target master cylinder fluid pressure P*mc is smaller than the service brake permissible fluid pressure Th_P, the pumps 31P and 31S are forced to run.

In the following, operation of the brake fluid pressure control system of the sixth embodiment will be described.

In case wherein a rapid braking is carried out, the difference between the required brake cylinder fluid pressure and to the present brake cylinder fluid pressure is large and the gradient of the pressure increasing rate is high. In this condition, it is difficult to rapidly and timely provide the brake cylinder with the required fluid pressure only by the boosting operation of the electric booster 22.

Accordingly, in the sixth embodiment of the invention, upon a rapid braking, the pumps 31P and 31S are also operated together with the electric booster 22.

FIG. 20 is a time chart depicting operation manner of the brake fluid pressure control system of the sixth embodiment upon a rapid braking. Upon rapid braking, the pumps 31P and 31S are forced to run prior to the time when the target master cylinder fluid pressure exceeds the service brake permissible fluid pressure. With this, the fluid pressure fed to the brake cylinder can have a faster responsiveness.

In the following, advantages of the sixth embodiment will be described.

(10) In the sixth embodiment, the yaw rate sensor 65, the lateral acceleration sensor 66, the longitudinal acceleration sensor 67, the steering angle sensor 11 and the brake controller 6 are mainly operated. That is, when a predetermined vehicle behavior is detected by the operation of the yaw rate sensor 65, lateral acceleration sensor 66, longitudinal acceleration sensor 67 and steering angle sensor 11, the brake fluid pressure controller 62 increases the brake cylinder fluid pressure to the required fluid pressure. When, with the present brake cylinder fluid pressure being smaller than a predetermined fluid pressure (viz., service brake permissible fluid pressure), the difference between the required brake cylinder fluid pressure and the present brake cylinder fluid pressure is large or the gradient of the pressure increasing rate is high, the electric booster 22 is operated by the service brake controller 60 and at the same time the pumps 31P and 31S are operated by the brake fluid pressure controller 62.

Accordingly, when the difference between the required brake cylinder fluid pressure and the present brake cylinder fluid pressure is large or the gradient of the pressure increasing rate for the required brake cylinder fluid pressure is high, the pumps 31P and 31S are forced to run prior to the time when the is required master cylinder fluid pressure exceeds the service brake permissible fluid pressure, which increases the responsiveness of the fluid pressure applied to the brake cylinder.

### Seventh Embodiment (E-7)

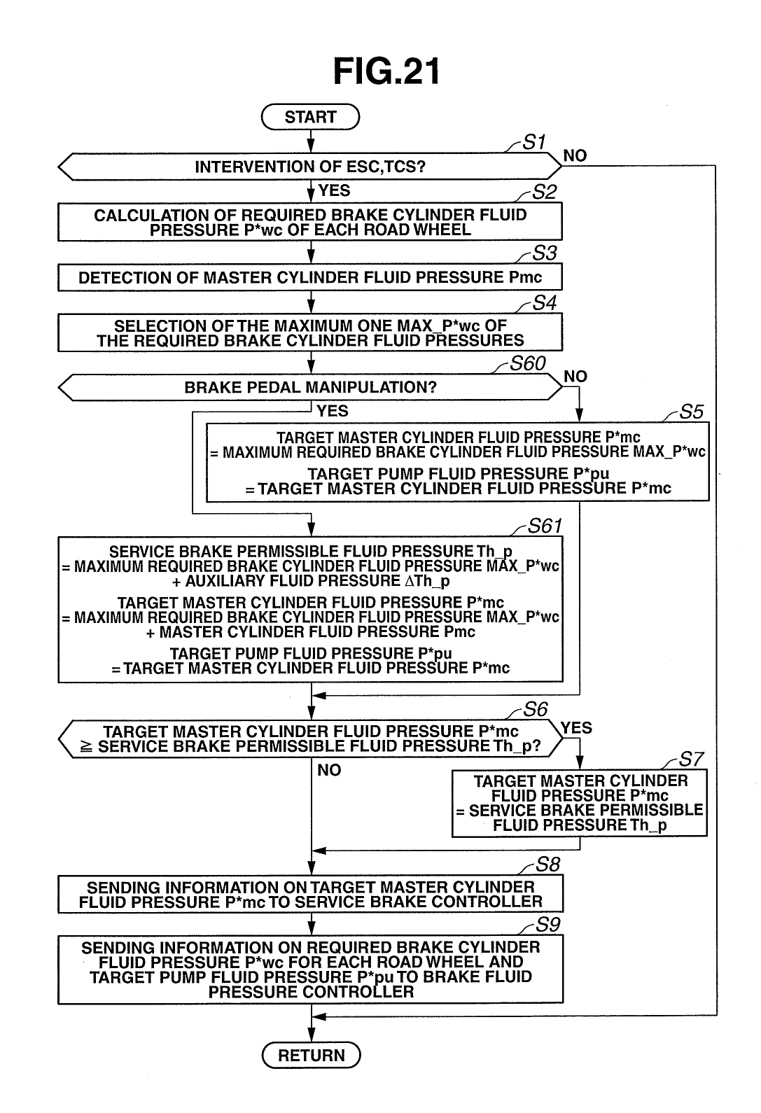

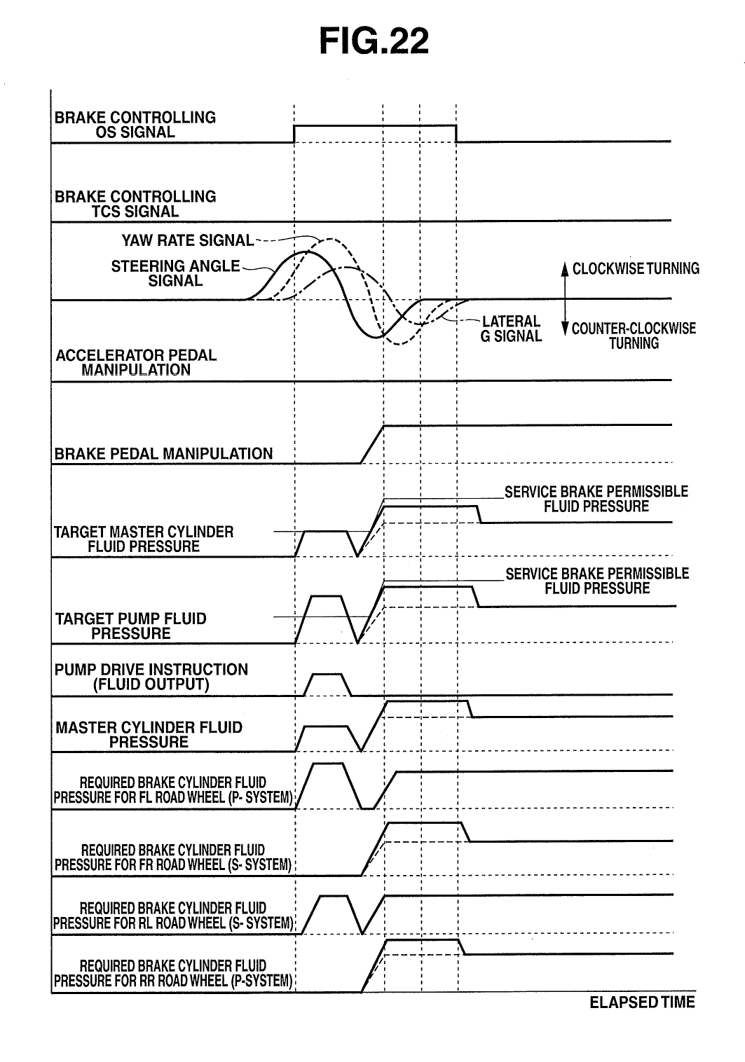

In the following, a seventh embodiment E-7 of the present invention will be described with reference to FIGS. 21 and 22.

In the seventh embodiment, measurements are employed for solving weak points that would appear when, during the vehicle behavior stabilizing control, the brake pedal is manipulated by a driver.

Referring to FIG. 21, there is shown a flowchart depicting programmed operation steps executed in the seventh embodiment.

In this seventh embodiment, new operation steps S60 and S61 are added to the flowchart of the above-mentioned first embodiment at a position just after the operation step S4 of the first embodiment.

Since the operation steps are substantially the same as those of the first embodiment except the new steps S60 and S61, the following explanation will be directed to only the new steps S60 and S61 for simplification of the description.

At step S60, judgment is carried out as to whether the brake pedal 20 has been manipulated or not by a driver. If YES, that is, when it is judged that the brake pedal 20 has been manipulated, the operation flow goes to step S61, and if NO, that is, when it is judged that the brake pedal 20 has not been manipulated, the operation flow goes to step S5.

At step S61, the service brake permissible fluid pressure Th_P is set to a value provided by adding a corrected fluid pressure ΔTh_P set in accordance with a manipulated variable of the brake pedal by a driver to the maximum required brake cylinder fluid pressure MAX P*wc. The manipulated variable of the brake pedal is derived from information signal on the brake is pedal stroke variable issued from the stroke sensor 26. Furthermore, the target master cylinder fluid pressure P*mc to be produced through the electric booster 22 is set to a value provided by adding the master cylinder fluid pressure Pmc detected at step S3 to the maximum required brake cylinder fluid pressure MAX P*wc, and the target pump fluid pressure P*pu to be produced through the pumps 31P and 31S is set to the target master cylinder fluid pressure P*mc, and the operation flow goes to step S6.

In the following, operation of the brake fluid pressure control system of the seventh embodiment of the invention will be described.

As is known, when the braking is being made by a driver who is manipulating the brake pedal, the driver is suppressed from suffering uncomfortable feeling even when a brake pedal stroll is produced. In order to ensure responsiveness of the braking force, it is preferable to boost the brake pedal manipulating force of the driver by operating the electric booster 22.

Accordingly, in the seventh embodiment, the pressure value provided by adding the corrected fluid pressure set in accordance with the brake pedal operation of the driver to the maximum required brake cylinder fluid pressure is set to the service brake permissible fluid pressure, and the target master cylinder fluid pressure is set to the value provided by adding the master cylinder fluid pressure to the maximum required brake cylinder fluid pressure.

FIG. 22 is a time chart depicting operation manner of the brake fluid pressure control system of the seventh embodiment under the vehicle behavior stabilizing control. More specifically, the time chart of FIG. 22 shows a case in which, under the vehicle behavior stabilizing control, a braking is carried out by a driver who manipulates the brake pedal 20.

When a braking action takes place, the service brake permissible fluid pressure is set to a larger value in accordance with the braking, and due to the work of the electric booster 22, the brake pedal operation force provided by the driver is boosted. Accordingly, satisfied responsiveness of the brake cylinder fluid pressure upon the braking is ensured.

In the following, advantages of the seventh embodiment will be described.

(11) In the seventh embodiment, the stroke sensor 26 and the brake controller 6 are mainly operated. When increase of the brake pedal stroke variable by a driver is detected by the stroke sensor 26, the target master cylinder fluid pressure (or corrected required wheel brake cylinder fluid pressure) provided by adding the fluid pressure produced by the braking operation of the driver to the maximum required brake cylinder fluid pressure is produced with the operation of the electric booster 22.

Accordingly, sufficient responsiveness of the fluid pressure applied to the brake cylinder at the time when the brake pedal is manipulated by the driver can be ensured.

### Eighth Embodiment (E-8)

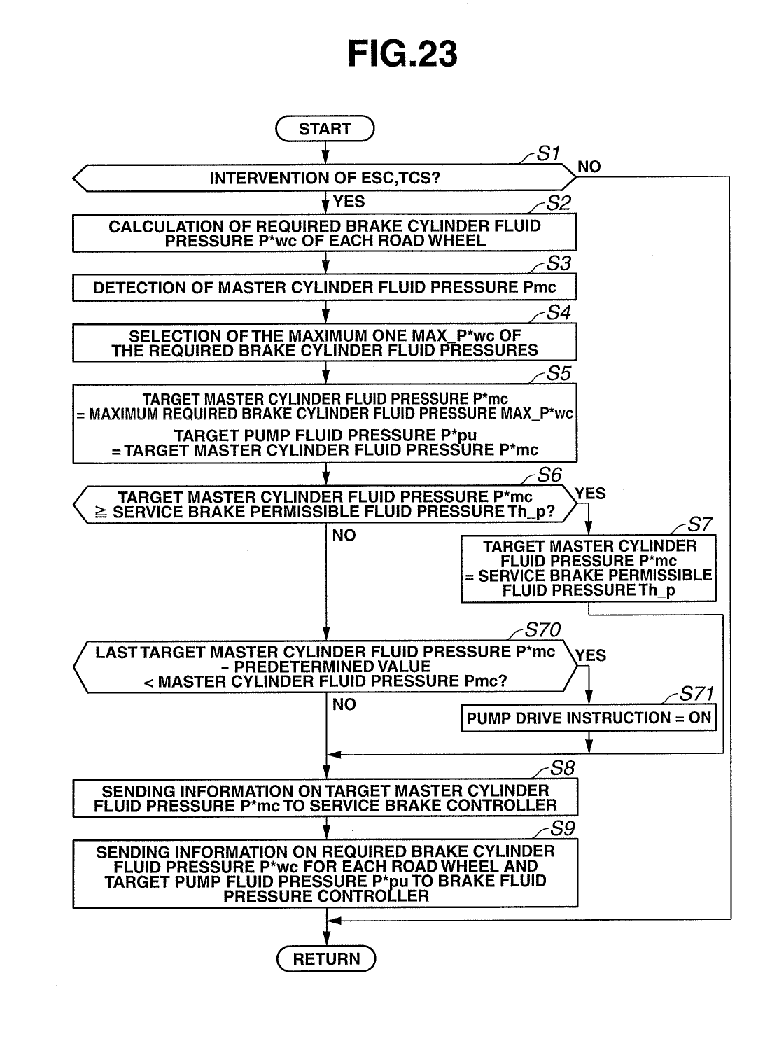

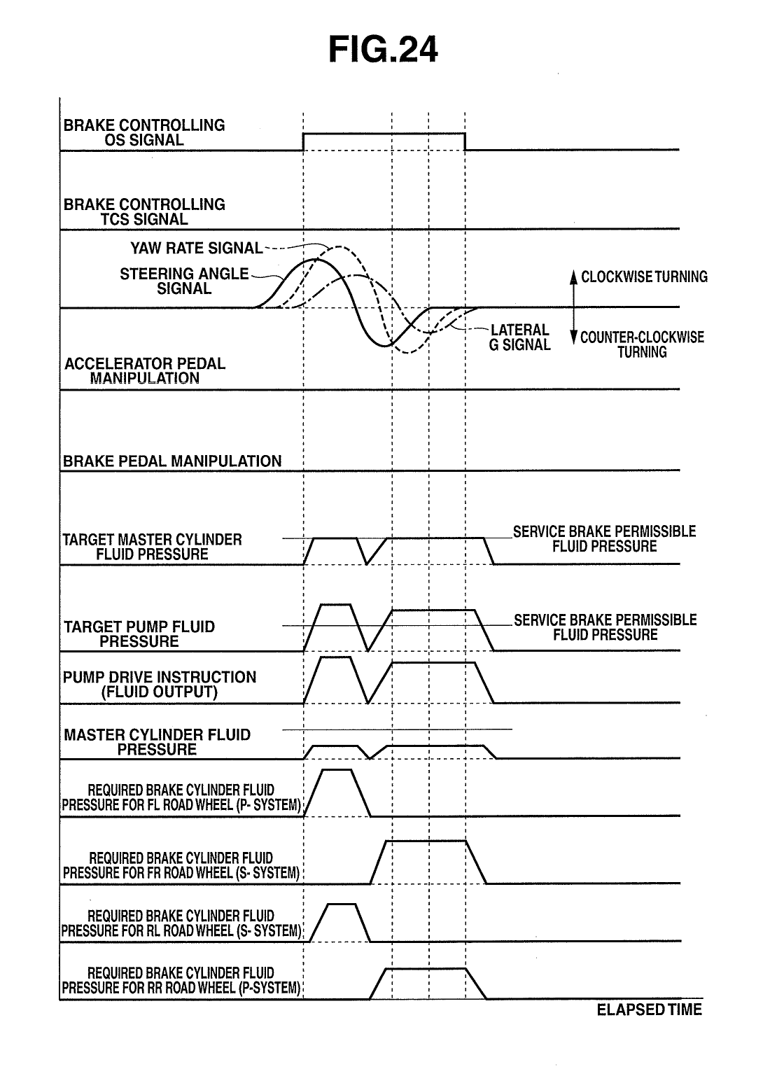

In the following, an eighth embodiment E-8 of the present invention will be described with reference to FIGS. 23 and 24.

In the eighth embodiment, measurements are employed for solving weak points that would appear when, under the vehicle behavior stabilizing control, the master cylinder fluid pressure is produced by the electric booster 22, the detected master cylinder fluid pressure is lower than the target master cylinder fluid pressure.

Referring to FIG. 23, there is shown a flowchart depicting programmed operation steps executed in the eighth embodiment.

In this eighth embodiment, new operation steps S70 and S71 are added to the flowchart of the above-mentioned first embodiment at a position just after the operation step S6 of the first embodiment.

Since the operation steps are substantially the same as those of the first embodiment except the new steps S70 and S71, the following explanation will be directed to only the new steps S70 and S71 for simplification of the description.

At step S70, judgment is carried out as to whether or not a value provided by subtracting a predetermined value from the last target master cylinder fluid pressure P*mc is smaller than the master cylinder fluid pressure Pmc detected by the master cylinder fluid pressure sensor 25. If YES, that is, when it is judged that the value is smaller than the detected master cylinder fluid pressure Pmc, the operation flow goes to step S8, and if NO, that is, when it is judged that the value is larger than the detected master cylinder fluid pressure Pmc, the operation flow goes to step S71. This judgment aims to check whether or not the actual master cylinder fluid pressure Pmc has been sufficiently produced with respect to the target master cylinder fluid pressure P*mc. The predetermined value used is determined by taking the responsiveness of the master cylinder fluid pressure Pmc relative to the target master cylinder fluid pressure P*mc.

At step S71, the pumps 31P and 31S are forced to run and the operation flow goes to step S8. That is, even when the target master cylinder fluid pressure P*mc is smaller than the service brake permissible fluid pressure Th_P, the pumps 31P and 31S are forced to run.

In the following, operation of the brake fluid pressure control system of the eighth embodiment will be described.

The electric booster 22 is operated based on the target master cylinder fluid pressure. However, due to time-related deterioration of parts of the electric booster 22, it sometimes occurs that the master cylinder fluid pressure can not be sufficiently increased by the booster 22 with respect to the target is master cylinder fluid pressure.

Accordingly, in the eighth embodiment, even when the target master cylinder fluid pressure is lower than the service brake permissible fluid pressure, the pumps 31P and 31S are forced to run when the master cylinder fluid pressure is not sufficiently increased with respect to the target master cylinder fluid pressure.

FIG. 24 is a time chart depicting operation manner of the brake fluid pressure control system of the eighth embodiment under the vehicle behavior stabilizing control. More specifically, the time chart of FIG. 24 shows a case in which the oversteer suppressing control is being carried out. As is seen from this time chart, even when the target master cylinder fluid pressure is lower than the service brake permissible fluid pressure, the pumps 31P and 31S are forced to run since the master cylinder fluid pressure is lower than the target master cylinder fluid pressure. That is, even when the master cylinder fluid pressure is not ready to be sufficiently increased by the electric booster 22, the master cylinder fluid pressure can be ensured by the pumps 31P and 31S.

In the following, advantages of the eighth embodiment will be described.

(12) In the eighth embodiment, the master cylinder fluid pressure sensor 25 and the brake controller 6 are mainly operated. When, with the brake cylinder fluid pressure being lower than a predetermined pressure (viz., service brake permissible fluid pressure), the master cylinder fluid pressure detected by the sensor 25 is lower than a predetermined master cylinder fluid pressure thereby judging that any one of the brake cylinders shows a lack of fluid pressure, the fluid pressure in the brake cylinder is increased by the pumps 31P and 31S.

Accordingly, even when the master cylinder fluid pressure is can not be sufficiently increased by the electric booster 22, the master cylinder fluid pressure can be ensured by the operation of the pumps 31P and 31S.

### Ninth Embodiment (E-9)

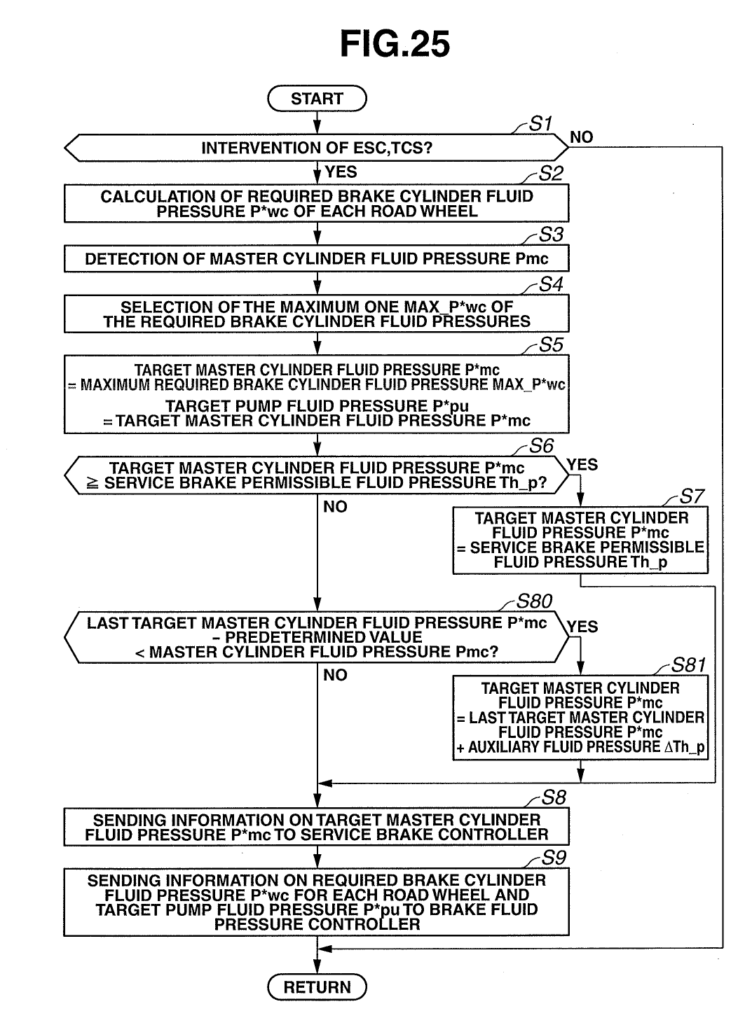

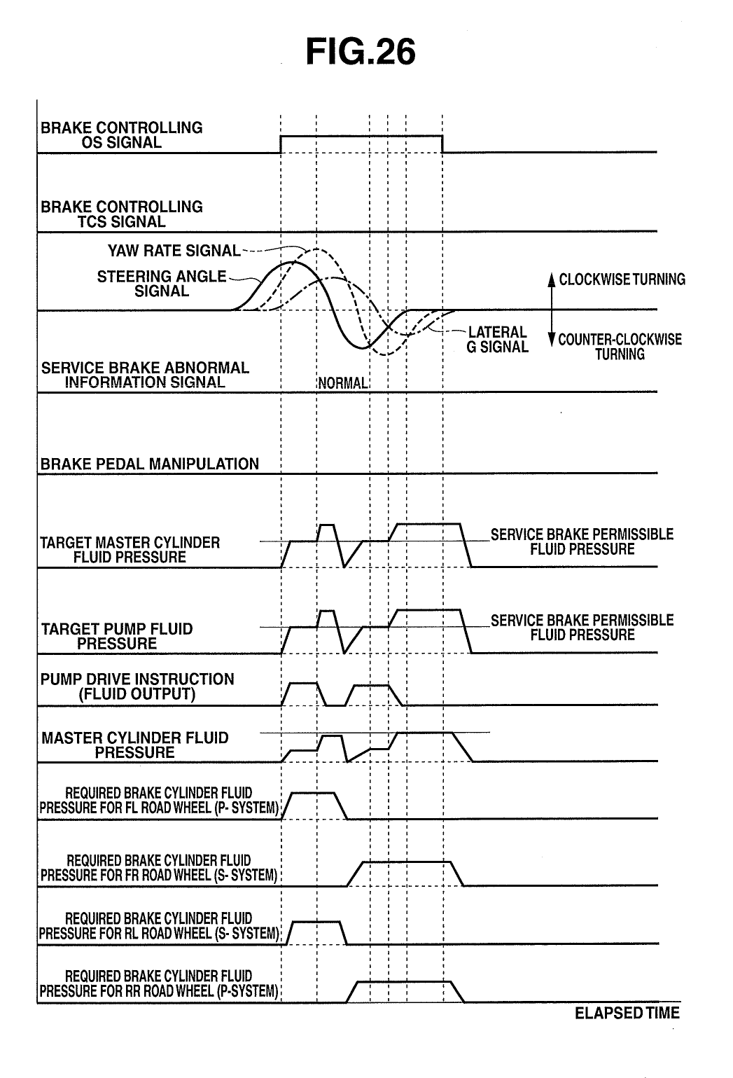

In the following, a ninth embodiment E-9 of the present invention will be described with reference to FIGS. 25 and 26.

In the ninth embodiment, measurements are employed for solving weak points that would appear when, upon production of the fluid pressure for the master cylinder by the electric booster 22 under the vehicle behavior stabilizing control, the detected master cylinder fluid pressure is lower than the target master cylinder fluid pressure.

Referring to FIG. 25, there is shown a flowchart depicting programmed operation steps executed in the ninth embodiment.

In the night embodiment, new operation steps S80 and S81 are added to the flowchart of the above-mentioned first embodiment at a position just after step S6 of the first embodiment.

Since the operation steps are substantially the same as those of the first embodiment except the new steps S80 and S81, the following explanation will be directed to only the new steps S80 and S81 for simplification of the description.

At step S80, judgment is carried out as to whether or not a value provided by subtracting a predetermined value from the last target master cylinder fluid pressure P*mc is smaller than the master cylinder fluid pressure Pmc detected by the master cylinder fluid pressure sensor 25. If YES, that is, when it is judged that the value provided by subtracting the predetermined value from the last target master cylinder fluid pressure P*mc is smaller than the detected master cylinder fluid pressure Pmc, the operation flow goes to step S81, and if NO, that is, when it is judged that the value provided by subtracting the predetermined value from the last target master cylinder fluid pressure P*mc is not smaller than the detected master cylinder fluid pressure Pmc, the operation flow goes to step S8. This judgment aims to check whether or not the actual master cylinder fluid pressure Pmc has been sufficiently produced with respect to the target master cylinder fluid pressure P*mc. The predetermined value used is determined by taking the responsiveness of the master cylinder fluid pressure Pmc relative to the target master cylinder fluid pressure P*mc.

At step S81, the target master cylinder fluid pressure P*mc is updated by adding an assist fluid pressure to the last target master cylinder fluid pressure P*mc, and the operation flow goes to step S8.

In the following, operation of the brake fluid pressure control system of the ninth embodiment will be described.

The electric booster 22 is operated based on the target master cylinder fluid pressure. However, due to time-related deterioration of parts of the electric booster 22, it sometimes occurs that the master cylinder fluid pressure can not be sufficiently increased by the booster 22 with respect to the target master cylinder fluid pressure.

Accordingly, in the ninth embodiment, when, with the target master cylinder fluid pressure being smaller than the service brake permissible fluid pressure, the master cylinder fluid pressure is not sufficiently increased with respect to the target master cylinder fluid pressure, a correction operation is carried out for increasing the target master cylinder fluid pressure.

FIG. 26 is a time chart depicting operation manner of the to brake fluid pressure control system of the ninth embodiment under the vehicle behavior stabilizing control. More specifically, the time chart of FIG. 26 shows a case in which the oversteer suppressing control is being carried out. As is seen from this time chart, when the master cylinder fluid pressure is lower than the target master cylinder fluid pressure, the target master cylinder fluid pressure is corrected to be increased. With this, the master cylinder fluid pressure can be sufficiently increased by the electric booster 22 and thus the fluid pressure for the brake cylinders of the road wheels is ensured.

In the following, advantages of the ninth embodiment will be described.

(13) In the ninth embodiment, the master cylinder fluid pressure sensor 25 and the brake controller 5 are mainly operated. When, with the brake cylinder fluid pressure being lower than the predetermined value (viz., service brake permissible fluid pressure), the detected master cylinder fluid pressure is lower than the predetermined master cylinder fluid pressure, a target master cylinder fluid pressure correction section (viz., step S81) operates the electric booster 22 in such a manner as to cause the master cylinder fluid pressure to take the target pressure. With this, the master cylinder fluid pressure can be sufficiently increased thereby to ensure the brake cylinder fluid pressure.

### Tenth Embodiment (E-10)

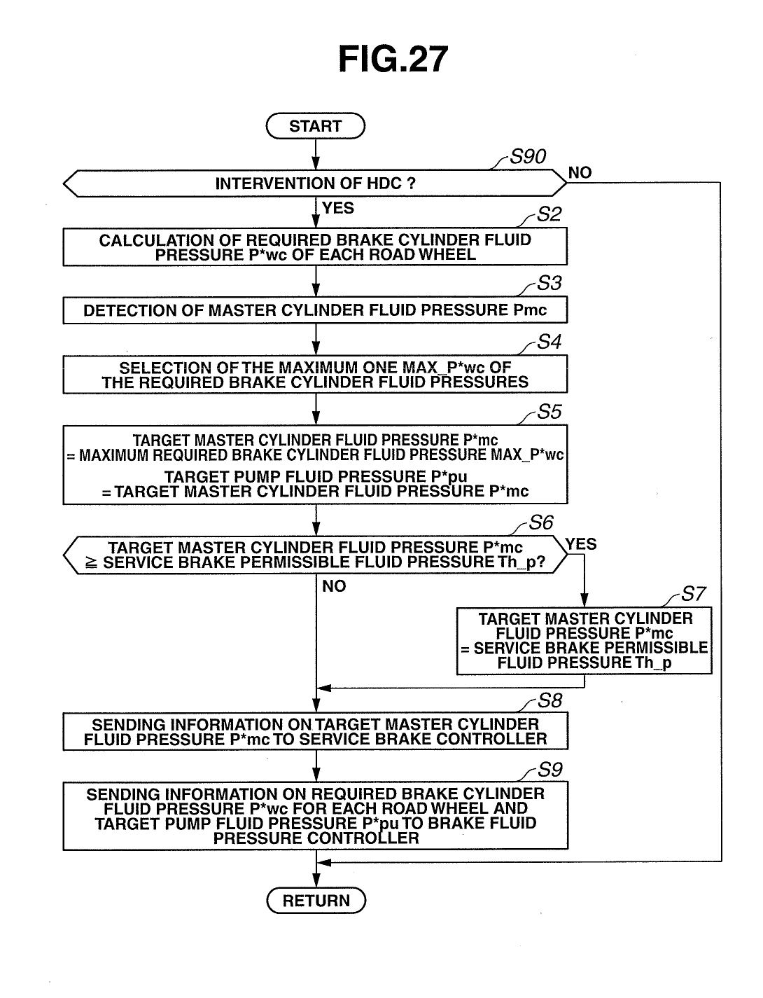

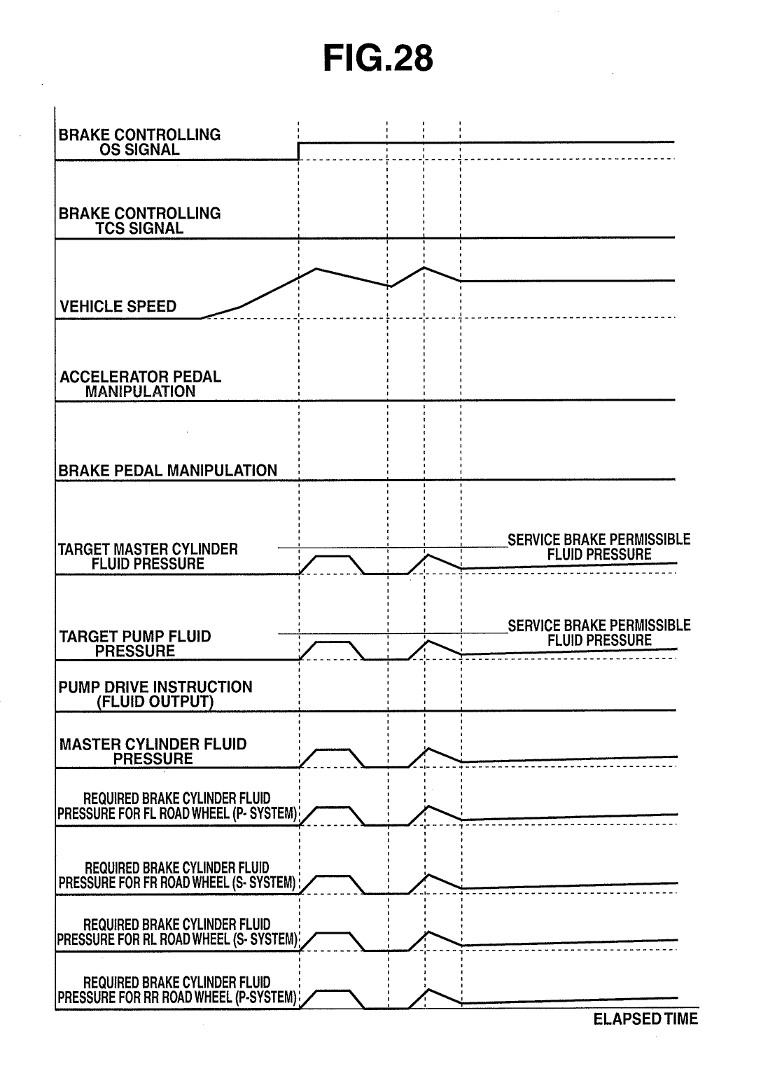

In the following, a tenth embodiment E-10 of the present invention will be described with reference to FIGS. 27 and 28.

In the tenth embodiment, measurements are employed for solving weak points that would appear when the vehicle is under constant speed running control, like HDC (viz., Hill Descent Control).

Referring to FIG. 27, there is shown a flowchart depicting programmed operation steps executed in the tenth embodiment.

In the tenth embodiment, a new operation step S90 is employed in the above-mentioned first embodiment in place of step S1.

Since the operation steps are substantially the same as those of the first embodiment except the new step S90, the following explanation will be directed to only the new step S90 for simplification of the description.

At step S90, judgment is carried out as to whether HDC (or constant speed running control) has intervened or not. If YES, that is, when it is judged that the HDC has intervened, the operation flow goes to step S2, and if NO, that is, when it is judged that the HDC has not intervened, the operation flow goes to END.

In the following, operation of the brake fluid pressure control system of the tenth embodiment will be described.

Like the vehicle behavior stabilizing control explained in the above-mentioned first embodiment, usually the constant speed running control is carried out at the time when braking is not effected. Accordingly, when, under such control, the pumps 31P and 31S and the electric motor 32 are operated, noises produced by such devices are easily sensed by the passengers.

Accordingly, in the tenth embodiment, when, under the constant speed running control, the target master cylinder fluid pressure is smaller than the service brake permissible fluid pressure, increase of the brake cylinder fluid pressure is effected by the electric booster 22.

FIG. 28 is a time chart depicting operation manner of the brake fluid pressure control system of the tenth embodiment under the vehicle behavior stabilizing control. As is seen from the time chart, when, under the constant speed running control, the target master cylinder fluid pressure is lower than the service brake permissible fluid pressure, the fluid pressure of the brake cylinders is increased by only operation of the electric booster 22 without the aid of the pumps 31P and 31S. Like in the first embodiment, when the target master cylinder fluid pressure is higher than the service brake permissible fluid pressure, the electric booster 22 as well as the pumps 31P and 31S are operated for rapidly increasing the brake cylinder fluid pressure.

With the above, the electric booster 22 can be operated in an operation range that does not induce a stroke of the brake pedal 20, and thus, part of the fluid pressure that would show a shortage when the fluid pressure increase is effected by only the electric booster 22 is compensated by the pumps 31P and 31S. Accordingly, a driver can be protected from feeling uncomfortable that would be caused by the stroke of the brake pedal 20. Furthermore, since operation of the pumps 31P and 31S is controlled or restrained, the pumps 31P and 31S and the electric motor 32 can be made small in size, which solves the problem of noises.

In the following, advantages of the tenth embodiment will be described.

(14) In the tenth embodiment, the ABS/TCS/ESC/HDC (Anti-lock Brake System/Traction Control System/Electronic Stability Control/Hill Descent Control) controller 61 and the brake controller 6 are mainly operated. That is, when the brake cylinder fluid pressure is lower than a predetermined pressure (viz., service brake permissible fluid pressure), the electric booster 22 is operated by the service brake controller 60.

Accordingly, a driver can be protected from feeling uncomfortable that would be caused by the stroke of the brake pedal 20. Furthermore, since operation of the pumps 31P and 31S is controlled or restrained, the pumps 31P and 31S and the electric motor 32 can be made small in size, which solves the noise problem.

### Other Embodiments (E-11)

In the above-mentioned first to fifth embodiments E-1 to E-5 and seventh to ninth embodiments E-7 to E-9, it is explained that an oversteer suppressing control is employed as the vehicle behavior stabilizing control. However, if desired, in place of the oversteer suppressing control, a slide sideways suppressing is control or a lane-keeping control may be employed as the vehicle behavior stabilizing control.

In the tenth embodiment E-10, the HDC is employed as the vehicle behavior stabilizing control. However, if desired, in place of the HDC, ACC control (viz., active cruising control) may be employed.

The entire contents of Japanese Patent Application 2012-158840 filed Jul. 17, 2012 are incorporated herein by reference.

Although the invention has been described above with reference to the embodiments of the invention, the invention is not limited to such embodiments as described above. Various modifications and variations of such embodiments may be carried out by those skilled in the art, in light of the above description.

What is claimed is:

1. A brake fluid pressure control system of a motor vehicle, comprising:
a master cylinder that produces a fluid pressure in response to a brake pedal manipulation by a driver;
electric pumps that increase the fluid pressure in the master cylinder when operated;
an upstream side brake fluid pressure controlling device that boosts the fluid pressure in the master cylinder;
electric control valves arranged between the master cylinder and a cluster of the brake cylinders of road wheels of the vehicle;
a downstream side brake fluid pressure controlling device that controls the fluid pressure of the brake cylinders with the aid of operation of the electric pumps and the electric control valves; and
a control unit that controls the upstream and downstream side brake fluid pressure controlling devices,
wherein the control unit comprises:
a required brake cylinder fluid pressure calculating section that calculates a required brake cylinder fluid pressure in accordance with a behavior of the vehicle;
a first brake cylinder fluid pressure controlling section that controls the upstream side brake fluid pressure controlling device for obtaining the required brake cylinder fluid pressure thus calculated; and
a second brake cylinder fluid pressure controlling section that controls the downstream side brake fluid pressure controlling device for increasing the brake cylinder fluid pressure thus obtained by the first brake cylinder fluid pressure controlling section.

2. A brake fluid pressure control system as claimed in claim 1, in which:
the required brake cylinder fluid pressure calculating section calculates respective fluid pressures required by the brake cylinders of the road wheels of the vehicle;
the first brake cylinder fluid pressure controlling section is equipped with a target master cylinder fluid pressure calculating section that calculates a target master cylinder fluid pressure based on the maximum one of the calculated fluid pressures required by the brake cylinders, and
the upstream side brake fluid pressure controlling device is operated to obtain the target master cylinder fluid pressure thus calculated.

3. A brake fluid pressure control system as claimed in claim 2, in which the control unit comprises an actual brake cylinder fluid pressure calculating section that calculates an actual fluid pressure in each brake cylinder, and in which when the actual brake cylinder fluid pressure calculated becomes coincident with the required brake cylinder fluid pressure, the brake cylinder fluid pressure is maintained by the electric control valves of the downstream side brake fluid pressure controlling device.

4. A brake fluid pressure control system as claimed in claim 2, further comprising a failure detecting means that detects a failure of the upstream side brake fluid pressure controlling device, and in which when the failure of the upstream side brake fluid pressure controlling device is detected by the failure detecting means, the control unit operates the downstream side brake fluid pressure controlling device with the aid of the second brake cylinder fluid pressure producing section thereby to produce a fluid pressure corresponding to the target master cylinder fluid pressure.

5. A brake fluid pressure control system as claimed in claim 2, further comprising a master cylinder fluid pressure calculating section that calculates the fluid pressure in the master cylinder and an anti-lock brake control unit that senses the possibility of lock of any road wheel and controls the fluid pressure for the brake cylinder of the road wheel to avoid the lock of the road wheel, and in which when, under operation of the upstream side brake fluid pressure controlling device, the calculated master cylinder fluid pressure is increased due to the control of the brake cylinder fluid pressure by the anti-lock brake control unit, the control unit causes the first brake cylinder fluid pressure controlling section to reduce the master cylinder fluid pressure and in which when, under operation of the upstream side brake is fluid pressure controlling device, the calculated master cylinder fluid pressure is reduced due to the control of the brake cylinder fluid pressure by the anti-lock brake control unit, the control unit causes the first brake cylinder fluid pressure controlling section to increase the master cylinder fluid pressure.

6. A brake fluid pressure control system as claimed in claim 1, in which until the time when the required brake cylinder fluid pressure increases to a predetermined fluid pressure, the control unit causes the first brake cylinder fluid controlling section to operate the upstream side brake fluid pressure controlling device, and when the required brake cylinder fluid pressure exceeds the predetermined fluid pressure, the control unit causes the second brake cylinder fluid pressure controlling section to operate the downstream side brake fluid pressure controlling device while keeping the operation of the upstream side brake fluid pressure controlling device by the first brake cylinder fluid controlling section, thereby obtaining and realizing the required master cylinder fluid pressure.

7. A brake fluid pressure control system as claimed in claim 6, further comprising a vehicle behavior stabilizing controller that is in cooperation with the downstream side brake fluid pressure controlling device, and in which when, with the brake cylinder fluid pressure being smaller than the predetermined fluid pressure, the vehicle behavior stabilizing controller finds that any one of brake cylinders is subjected to a lack of fluid pressure, the control unit causes the upstream side brake fluid pressure controlling device to increase the fluid pressure of the brake cylinder.

8. A brake fluid pressure control system as claimed in claim 6, further comprising a vehicle behavior detecting section that is detects a behavior of the vehicle and a vehicle behavior controlling section that increases the fluid pressure of brake cylinder to the required brake cylinder fluid pressure when a certain behavior of the vehicle is detected by the vehicle behavior detecting section, and in which when, with the brake cylinder fluid pressure being smaller than the predetermined brake cylinder fluid pressure, a difference between the required brake cylinder fluid pressure and an actual brake cylinder fluid pressure is larger than a predetermined degree or a pressure increasing rate of the required brake cylinder fluid pressure is larger than a predetermined degree, the control unit causes the first brake cylinder fluid pressure controlling section to operate the upstream side brake fluid pressure controlling device and at the same time to cause the second brake cylinder fluid pressure controlling section to operate the downstream side brake fluid pressure controlling device.

9. A brake fluid pressure control system as claimed in claim 6, further comprising a brake pedal manipulation detecting means that detects manipulation of a brake pedal, and in which when the brake pedal manipulation detecting means detects an increase of the brake pedal manipulation, the control unit causes the first brake cylinder fluid pressure controlling section to produce a corrected required brake cylinder fluid pressure that is provided by adding a fluid pressure corresponding to the increase of the brake pedal manipulation to the required brake cylinder fluid pressure.

10. A brake fluid pressure control system as claimed in claim 6, further comprising a master cylinder fluid pressure detecting means that detects the fluid pressure in the master cylinder, and in which when, with the brake cylinder fluid pressure being lower than the predetermined fluid pressure, the master cylinder fluid pressure detected by the master cylinder fluid pressure detecting means is lower than a predetermined fluid pressure thereby judging that any one of the brake cylinders is subjected to a lack of fluid pressure, the control unit causes the downstream side brake fluid pressure controlling device to increase the fluid pressure for the brake cylinder of lack of fluid pressure.

11. A brake fluid pressure control system as claimed in claim 6, further comprising a master cylinder fluid pressure detecting means that detects the fluid pressure in the master cylinder and a target master cylinder fluid pressure correcting section that corrects the target master cylinder fluid pressure to a higher pressure, and in which when, with the brake cylinder fluid pressure being lower than the predetermined fluid pressure, the master cylinder fluid pressure detected by the master cylinder fluid pressure detecting means is lower than a predetermined fluid pressure, the control unit causes the target master cylinder fluid pressure correcting section to operate the upstream side brake fluid pressure controlling device in a manner to provide the master cylinder with the corrected and higher target master cylinder fluid pressure.

12. A brake fluid pressure control system as claimed in claim 6, further comprising a vehicle speed controlling section that provides the vehicle with a constant speed cruising by automatically controlling the fluid pressures in the brake cylinders, and in which when the brake cylinder fluid pressure is smaller than the predetermined fluid pressure, the vehicle speed controlling section causes the first brake cylinder fluid pressure controlling section to operate the upstream side brake fluid pressure controlling device.

13. A brake fluid pressure control system as claimed in claim 1, is in which in order to realize the required brake cylinder fluid pressure, the control unit causes the first brake cylinder fluid pressure controlling section to operate the upstream side brake fluid pressure controlling device until the time when a predetermined amount of the brake fluid is led to the selected brake cylinder, and causes the second brake cylinder fluid pressure controlling section to operate the downstream side brake fluid pressure controlling device while keeping the operation of the first brake cylinder fluid pressure controlling section for the upstream side brake fluid pressure controlling device after the time when the predetermined amount of the brake fluid has been led to the selected brake cylinder.

14. A brake fluid pressure control system as claimed in claim 1, further comprising a vehicle behavior detecting section that detects the vehicle behavior, in which the control unit includes a vehicle behavior controlling section that establishes the required brake cylinder fluid pressure when a predetermined vehicle behavior is detected by the vehicle behavior detecting section, and in which the vehicle behavior controlling section causes the first brake cylinder fluid pressure controlling section to operate the upstream side brake fluid pressure controlling device to increase the brake cylinder fluid pressure to a predetermined fluid pressure and causes the second brake cylinder fluid pressure controlling section to operate the downstream side brake fluid pressure controlling device to produce a fluid pressure that corresponds to a difference between the required brake cylinder fluid pressure and the fluid pressure produced by the first brake cylinder fluid pressure controlling section.

15. A brake fluid pressure control system of a motor vehicle, comprising:
a master cylinder that produces a fluid pressure in response to a brake pedal manipulation by a driver;
electric pumps that increase the fluid pressure in the master cylinder when operated;
an upstream side brake fluid pressure controlling device that boosts the fluid pressure in the master cylinder;
electric control valves arranged between the master cylinder and a cluster of the brake cylinders of road wheels of the vehicle;
a downstream side brake fluid pressure controlling device that controls the fluid pressure of the brake cylinders with the aid of operation of the electric pumps and the electric control valves;
a required brake cylinder fluid pressure calculating section that calculates a required brake cylinder fluid pressure required by each brake cylinder based on a vehicle behavior;
a first brake cylinder fluid pressure controlling section that causes the upstream side brake fluid pressure controlling device to operate until the time when the brake cylinder fluid pressure is increased to a predetermined fluid pressure; and
a second brake cylinder fluid pressure controlling section that causes the downstream side brake fluid pressure controlling device to boost the increased brake fluid pressure after the time when the brake cylinder fluid pressure exceeds the predetermined fluid pressure.

16. A brake fluid pressure control system as claimed in claim 15, in which:
the required brake cylinder fluid pressure calculating to section calculates the fluid pressure required by each of the brake cylinders of the road wheels of the vehicle, and
in which the first brake cylinder fluid pressure controlling section is equipped with a target master cylinder fluid pressure calculating section that calculates a target master cylinder fluid is pressure based on the maximum one of the required brake cylinder fluid pressures calculated by the required brake cylinder fluid pressure calculating section, and the first brake cylinder fluid pressure controlling section operates the upstream side brake fluid pressure controlling device in a manner to fill the selected brake cylinder with the calculated required brake cylinder fluid pressure.

17. A brake fluid pressure controlling system as claimed in claim 16, further comprising an actual brake cylinder fluid pressure calculating section that calculates a brake cylinder pressure actually appearing in each brake cylinder, and in which when the calculated actual brake cylinder fluid pressure becomes coincident with the required brake cylinder fluid pressure, the second brake cylinder fluid pressure controlling section causes the electric control valves of the downstream side brake fluid pressure controlling device to operate in a manner to keep the brake cylinder fluid pressure.

18. A brake fluid pressure control system as claimed in claim 17, in which in order to obtain and realize the required brake cylinder fluid pressure, the control unit causes the first brake cylinder fluid pressure controlling section to operate the upstream side brake fluid pressure controlling device until the time when a predetermined amount of the brake fluid is led to the selected brake cylinder, and causes the second brake cylinder fluid pressure controlling section to operate the downstream side brake fluid pressure controlling device while keeping the operation of the first brake cylinder fluid pressure controlling section for the upstream side brake fluid pressure controlling device after the time when the predetermined amount of the brake fluid has been led to the selected brake cylinder.

19. A brake fluid pressure control system as claimed in claim 18, further comprising an upstream side failure detecting means that detects a failure of the upstream side brake fluid pressure controlling device, and in which when a failure of the upstream side brake fluid pressure controlling device is detected by the upstream side failure detecting means, the control unit causes the second brake cylinder fluid pressure controlling section to operate the downstream side fluid pressure controlling device to produce a fluid pressure that corresponds to the target master cylinder fluid pressure.

20. In a hydraulic brake system of a motor vehicle that includes a master cylinder that produces a fluid pressure in response to a brake pedal manipulation by a driver, electric pumps that increase the fluid pressure in the master cylinder when operated; an upstream side brake fluid pressure controlling device that boosts the fluid pressure in the master cylinder, electric control valves arranged between the master cylinder and a cluster of the brake cylinders of road wheels of the vehicle; and a downstream side brake fluid pressure controlling device that controls the fluid pressure of the brake cylinders with the aid of operation of the electric pumps and the electric control valves,
a method of controlling the hydraulic brake system comprising:
calculating a fluid pressure required by a selected brake cylinder of a road wheel based on a behavior of the motor vehicle;
operating the upstream side brake fluid pressure controlling to device until the time when the required brake cylinder fluid pressure increases to a predetermined fluid pressure; and
operating the downstream side brake fluid pressure controlling device while keeping the operation of the upstream side brake fluid pressure controlling device after the time when is the required brake cylinder fluid pressure exceeds the predetermined fluid pressure.
